(19) United States
(12) Patent Application Publication
(10) Pub. No.: US 2025/0338280 A1
(43) Pub. Date: Oct. 30, 2025

(54) TECHNIQUES FOR CONFIGURING A TIMELINE AND QUANTITY OF DOWNLINK CONTROL CHANNEL DECODING CANDIDATES

(71) Applicant: QUALCOMM Incorporated, San Diego, CA (US)

(72) Inventors: Kangqi LIU, San Diego, CA (US); Gabi SARKIS, San Diego, CA (US); Mostafa KHOSHNEVISAN, San Diego, CA (US); Le LIU, San Jose, CA (US); Huilin XU, Temecula, CA (US); Weimin DUAN, San Diego, CA (US)

(21) Appl. No.: 18/649,811

(22) Filed: Apr. 29, 2024

(51) Int. Cl. H04W 72/23

(52) U.S. Cl. CPC H04W 72/23

(57) ABSTRACT

Methods, systems, and devices for wireless communications are described. A user equipment (UE) may transmit, to a network entity, capability information indicating multiple downlink processing time durations and multiple uplink preparation time durations associated with different quantities of downlink control channel decoding candidates. The UE may receive, based on the capability information, control messages indicating a set of time offsets associated with a quantity of downlink control channel decoding candidates. The third quantity of downlink control channel decoding candidates may be a quantity of downlink control channel decoding candidates of the different quantities of downlink control channel decoding candidates indicated in the capability information, and the set of time offsets may be based on a downlink processing time duration and uplink preparation time duration associated with the quantity of downlink control channel decoding candidates. The UE may monitor downlink control channel decoding candidates based on the control messages.

### FIELD OF TECHNOLOGY

The following relates to wireless communications, including techniques for configuring a timeline and quantity of downlink control channel decoding candidates.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may receive a physical downlink control channel (PDCCH) message and may determine, from the PDCCH message, resources for receiving a physical downlink shared channel (PDSCH) message or to transmit a physical uplink shared channel (PUSCH) message. In some examples, the UE may receive the PDCCH using blind decoding, in which the UE may attempt to locate a PDCCH over a search space by decoding a quantity of PDCCH candidates, such as resources of the search space that may be used to receive a PDCCH message at the UE.

### SUMMARY

The described techniques relate to improved methods, systems, devices, and apparatuses that support techniques for configuring a timeline and quantity of downlink control channel decoding candidates. For example, the described techniques provide for a user equipment (UE) to transmit capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. In other words, the UE may indicate processing and preparation capabilities associated with different quantities of downlink control channel decoding candidates. Based on the capability information, the UE may receive one or more control messages indicating multiple time offsets associated with a third quantity of downlink control channel decoding candidates. For example, the third quantity of downlink control channel decoding candidates may be one of the first quantity of downlink control channel decoding candidates or the second quantity of downlink control channel decoding candidates. In some examples, the network entity may select one of the first quantity or the second quantity to indicate in the one or more control messages. The multiple time offsets may be based on one of the first downlink processing time duration and the first uplink preparation time duration or the second downlink processing time duration and the second uplink preparation time duration. The UE may monitor one or more downlink control channel decoding candidates of the third quantity of downlink control channel decoding candidates based on the one or more control messages.

A method for wireless communications by a UE is described. The method may include transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates, receiving, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration, and monitoring one or more downlink control channel decoding candidates of the third quantity of downlink control channel decoding candidates based on the one or more control messages.

A UE for wireless communications is described. The UE may include one or more memories storing processor executable code, and one or more processors coupled with the one or more memories. The one or more processors may individually or collectively be operable to execute the code to cause the UE to transmit, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates, receive, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration, and monitor one or more downlink control channel decoding candidates of the third quantity of downlink control channel decoding candidates based on the one or more control messages.

Another UE for wireless communications is described. The UE may include means for transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates, means for receiving, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration, and means for monitoring one or more downlink control channel decoding candidates of the third quantity of downlink control channel decoding candidates based on the one or more control messages.

A non-transitory computer-readable medium storing code for wireless communications is described. The code may include instructions executable by one or more processors to transmit, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates, receive, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration, and monitor one or more downlink control channel decoding candidates of the third quantity of downlink control channel decoding candidates based on the one or more control messages.

In some examples of the method, UEs, and non-transitory computer-readable medium described herein, a first time duration between a downlink control channel and a downlink shared data channel corresponding to the downlink control channel, a second time duration between the downlink control channel and an uplink shared data channel, and a third time duration between the downlink shared data channel and a feedback channel.

In some examples of the method, UEs, and non-transitory computer-readable medium described herein, receiving the one or more control messages may include operations, features, means, or instructions for receiving the one or more control messages further indicating a second set of multiple time offsets associated with a fourth quantity of downlink control channel decoding candidates, where, the third quantity of downlink control channel decoding candidates includes the first quantity of downlink control channel decoding candidates, the fourth quantity of downlink control channel decoding candidates includes the second quantity of downlink control channel decoding candidates, the set of multiple time offsets may be based on the first downlink processing time duration and the first uplink preparation time duration, the second set of multiple time offsets may be based on the second downlink processing time duration and the second uplink preparation time duration, and the one or more control messages include one or more radio resource control (RRC) messages indicating to monitor one of the first quantity of downlink control channel decoding candidates or the second quantity of downlink control channel decoding candidates.

In some examples of the method, UEs, and non-transitory computer-readable medium described herein, receiving the one or more control messages may include operations, features, means, or instructions for receiving downlink control information indicating to monitor one of the first quantity of downlink control channel decoding candidates or the second quantity of downlink control channel decoding candidates.

Some examples of the method, UEs, and non-transitory computer-readable medium described herein may further include operations, features, means, or instructions for receiving control signaling deactivating downlink control channel skipping, where the third quantity of downlink control channel decoding candidates include at least one of, a quantity of the third quantity of downlink control channel decoding candidates, a difference between the third quantity of downlink control channel decoding candidates and a fourth quantity of downlink control channel decoding candidates when the downlink control channel skipping may be deactivated, and a ratio of the third quantity of downlink control channel decoding candidates and the fourth quantity of downlink control channel decoding candidates.

In some examples of the method, UEs, and non-transitory computer-readable medium described herein, receiving the one or more control messages may include operations, features, means, or instructions for receiving the one or more control messages indicating the set of multiple time offsets associated with the third quantity of downlink control channel decoding candidates and a second set of multiple time offsets associated with a fourth quantity of downlink control channel decoding candidates, where the set of multiple time offsets may be associated with a first search space set group (SSSG) and the second set of multiple time offsets may be associated with a second SSSG.

Some examples of the method, UEs, and non-transitory computer-readable medium described herein may further include operations, features, means, or instructions for receiving, from the network entity, an indication of a first row of a time domain resource allocation (TDRA) table associated with the first SSSG and a second row of the TDRA table associated with the second SSSG, receiving a switch command indicating to switch from the first SSSG to the second SSSG, and monitoring one or more second downlink control channel decoding candidates of the fourth quantity of downlink control channel decoding candidates in accordance with the second row of the TDRA table based on the switch command.

Some examples of the method, UEs, and non-transitory computer-readable medium described herein may further include operations, features, means, or instructions for receiving, from the network entity, a switch command indicating to switch from the first SSSG to the second SSSG and switching, based on the indication, from a first TDRA table associated with the first SSSG to a second TDRA associated with the second SSSG.

In some examples of the method, UEs, and non-transitory computer-readable medium described herein, the one or more control messages include one or more semi-persistent RRC messages.

Some examples of the method, UEs, and non-transitory computer-readable medium described herein may further include operations, features, means, or instructions for refraining from monitoring the one or more downlink control channel decoding candidates of the third quantity of downlink control channel decoding candidates based on one or more of a type of search space set being monitored by the UE, a downlink control information (DCI) format of the one or more control messages indicating the third quantity of downlink control channel decoding candidates, a radio network temporary identifier (RNTI) of the one or more control messages indicating the third quantity of downlink control channel decoding candidates, a reference signal type of one or more reference signals scheduled to be received by the UE via the one or more downlink control channel decoding candidates, or any combination thereof.

In some examples of the method, UEs, and non-transitory computer-readable medium described herein, the third quantity of downlink control channel decoding candidates associated with the set of multiple time offsets may be based on an amount of traffic of the UE satisfying a first threshold, an active number of UEs communicating with a cell serving the UE satisfying a second threshold, a delay sensitivity associated with providing service satisfying a third threshold, or a combination thereof.

A method for wireless communications by a network entity is described. The method may include receiving, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates, transmitting, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration, and transmitting a downlink control channel message based on the one or more control messages.

A network entity for wireless communications is described. The network entity may include one or more memories storing processor executable code, and one or more processors coupled with the one or more memories. The one or more processors may individually or collectively be operable to execute the code to cause the network entity to receive, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates, transmit, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration, and transmit a downlink control channel message based on the one or more control messages.

Another network entity for wireless communications is described. The network entity may include means for receiving, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates, means for transmitting, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration, and means for transmitting a downlink control channel message based on the one or more control messages.

A non-transitory computer-readable medium storing code for wireless communications is described. The code may include instructions executable by one or more processors to receive, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates, transmit, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration, and transmit a downlink control channel message based on the one or more control messages.

In some examples of the method, network entities, and non-transitory computer-readable medium described herein, a first time duration between a downlink control channel and a downlink shared data channel corresponding to the downlink control channel, a second time duration between the downlink control channel and an uplink shared data channel, and a third time duration between the downlink shared data channel and a feedback channel.

In some examples of the method, network entities, and non-transitory computer-readable medium described herein, transmitting the one or more control messages may include operations, features, means, or instructions for transmitting the one or more control messages further indicating a second set of multiple time offsets associated with a fourth quantity of downlink control channel decoding candidates, where, the third quantity of downlink control channel decoding candidates includes the first quantity of downlink control channel decoding candidates, the fourth quantity of downlink control channel decoding candidates includes the second quantity of downlink control channel decoding candidates, the set of multiple time offsets may be based on the first downlink processing time duration and the first uplink preparation time duration, the second set of multiple time offsets may be based on the second downlink processing time duration and the second uplink preparation time duration, and the one or more control messages include one or more RRC messages indicating to monitor one of the first quantity of downlink control channel decoding candidates or the second quantity of downlink control channel decoding candidates.

In some examples of the method, network entities, and non-transitory computer-readable medium described herein, transmitting the one or more control messages may include operations, features, means, or instructions for transmitting downlink control information indicating to monitor one of the first quantity of downlink control channel decoding candidates or the second quantity of downlink control channel decoding candidates.

Some examples of the method, network entities, and non-transitory computer-readable medium described herein may further include operations, features, means, or instructions for transmitting control signaling deactivating downlink control channel skipping at the UE, where the third quantity of downlink control channel decoding candidates include at least one of, a quantity of the third quantity of downlink control channel decoding candidates, a difference between the third quantity of downlink control channel decoding candidates and a fourth quantity of downlink control channel decoding candidates when the downlink control channel skipping may be deactivated, and a ratio of the third quantity of downlink control channel decoding candidates and the fourth quantity of downlink control channel decoding candidates.

In some examples of the method, network entities, and non-transitory computer-readable medium described herein, transmitting the one or more control messages may include operations, features, means, or instructions for transmitting the one or more control messages indicating the set of multiple time offsets associated with the third quantity of downlink control channel decoding candidates and a second set of multiple time offsets associated with a fourth quantity of downlink control channel decoding candidates, where the set of multiple time offsets may be associated with a first SSSG and the second set of multiple time offsets may be associated with a second SSSG.

Some examples of the method, network entities, and non-transitory computer-readable medium described herein may further include operations, features, means, or instructions for transmitting an indication of a first row of a TDRA table associated with the first SSSG and a second row of the TDRA table associated with the second SSSG and transmitting a switch command indicating to switch from the first SSSG to the second SSSG, where the UE may be to monitor one or more second downlink control channel decoding candidates of the fourth quantity of downlink control channel decoding candidates in accordance with the second row of the TDRA table based on the switch command.

Some examples of the method, network entities, and non-transitory computer-readable medium described herein may further include operations, features, means, or instructions for transmitting, to the UE, a switch command indicating to switch from the first SSSG to the second SSSG, where the UE may be to switch from a first TDRA table associated with the first SSSG to a second TDRA associated with the second SSSG.

In some examples of the method, network entities, and non-transitory computer-readable medium described herein, the one or more control messages include one or more semi-persistent RRC messages.

In some examples of the method, network entities, and non-transitory computer-readable medium described herein, the third quantity of downlink control channel decoding candidates associated with the set of multiple time offsets may be based on an amount of traffic of the UE satisfying a first threshold, an active number of UEs communicating with a cell serving the UE satisfying a second threshold, a delay sensitivity associated with providing service satisfying a third threshold, or a combination thereof.

### BRIEF DESCRIPTION OF THE DRAWINGS

FIGS. 1 and 2 show examples of wireless communications systems that support techniques for configuring a timeline and quantity of downlink control channel decoding candidates in accordance with one or more aspects of the present disclosure.

FIG. 3 shows an example of a timing diagram that supports techniques for configuring a timeline and quantity of downlink control channel decoding candidates in accordance with one or more aspects of the present disclosure.

FIG. 4 shows an example of a process flow that supports techniques for configuring a timeline and quantity of downlink control channel decoding candidates in accordance with one or more aspects of the present disclosure.

FIGS. 5 and 6 show block diagrams of devices that support techniques for configuring a timeline and quantity of downlink control channel decoding candidates in accordance with one or more aspects of the present disclosure.

FIG. 7 shows a block diagram of a communications manager that supports techniques for configuring a timeline and quantity of downlink control channel decoding candidates in accordance with one or more aspects of the present disclosure.

FIG. 8 shows a diagram of a system including a device that supports techniques for configuring a timeline and quantity of downlink control channel decoding candidates in accordance with one or more aspects of the present disclosure.

FIGS. 9 and 10 show block diagrams of devices that support techniques for configuring a timeline and quantity of downlink control channel decoding candidates in accordance with one or more aspects of the present disclosure.

FIG. 11 shows a block diagram of a communications manager that supports techniques for configuring a timeline and quantity of downlink control channel decoding candidates in accordance with one or more aspects of the present disclosure.

FIG. 12 shows a diagram of a system including a device that supports techniques for configuring a timeline and quantity of downlink control channel decoding candidates in accordance with one or more aspects of the present disclosure.

FIGS. 13 through 16 show flowcharts illustrating methods that support techniques for configuring a timeline and quantity of downlink control channel decoding candidates in accordance with one or more aspects of the present disclosure.

### DETAILED DESCRIPTION

A user equipment (UE) may monitor multiple downlink control channel decoding candidates, such as physical downlink control channel (PDCCH) candidates for downlink control channel messages. For example, downlink control channel messages may indicate resources for communicating data messages, such as for receiving a physical downlink shared channel (PDSCH) message, for transmitting a physical uplink shared channel (PUSCH) message, or both. However, in some cases, monitoring downlink control channel candidates may be associated with high energy consumption (e.g., over a day of use (DOU)) relative to other message types, such as physical uplink control channel (PUCCH), PDSCH, PUSCH, sounding reference signals (SRSs), or cell discontinuous reception (CDRX). Accordingly, a network entity may configure the UE with a reduced quantity of downlink control channel decoding candidates in a time duration to reduce energy consumption. However, the reduced quantity of downlink control channel decoding candidates may be limited by a throughput threshold (e.g., a quantity of PDCCH candidates to be decoded by a deadline) at the UE, which may correspond to one or more parameters at the UE, such as time offsets (e.g., k₀, k₁, and/or k₂), a search space periodicity, a quantity of aggregation level (AL) candidates, or the like. In other words, the UE may reduce hardware for receiving downlink control channel messages, lower a power usage, or both, by monitoring for the quantity of downlink control channel decoding candidates, performing blind decoding attempts, or both up to a threshold associated with a time duration.

For example, the described techniques provide for a UE to transmit capability information indicating a first downlink processing time duration (e.g., N₁) and a first uplink preparation time duration (e.g., N₂) associated with a first quantity of downlink control channel decoding candidates and a second downlink processing time duration and a second uplink preparation time duration associated with a second quantity of downlink control channel decoding candidates. In other words, the UE may indicate processing and preparation capabilities associated with different quantities of downlink control channel decoding candidates. Based on the capability information, the UE may receive one or more control messages indicating multiple time offsets (e.g., k₀, k₁, and/or k₂) associated with a third quantity of downlink control channel decoding candidates. In some examples, the network entity may select one of the first quantity or the second quantity of downlink control channel decoding candidates to indicate in the one or more control messages. The multiple time offsets may be based on one of the first downlink processing time duration and the first uplink preparation time duration or the second downlink processing time duration and the second uplink preparation time duration. For example, the network entity may determine the multiple time offsets to satisfy a threshold throughput while reducing a communications timeline. In other words, the network entity may minimize the multiple time offsets to improve throughput for the quantity of downlink control channel decoding candidates. The UE may monitor one or more downlink control channel decoding candidates of the third quantity of downlink control channel decoding candidates based on the one or more control messages.

Aspects of the disclosure are initially described in the context of wireless communications systems. Aspects of the disclosure are also described in the context of a timing diagram and a process flow. Aspects of the disclosure are further illustrated by and described with reference to apparatus diagrams, system diagrams, and flowcharts that relate to techniques for configuring a timeline and quantity of downlink control channel decoding candidates.

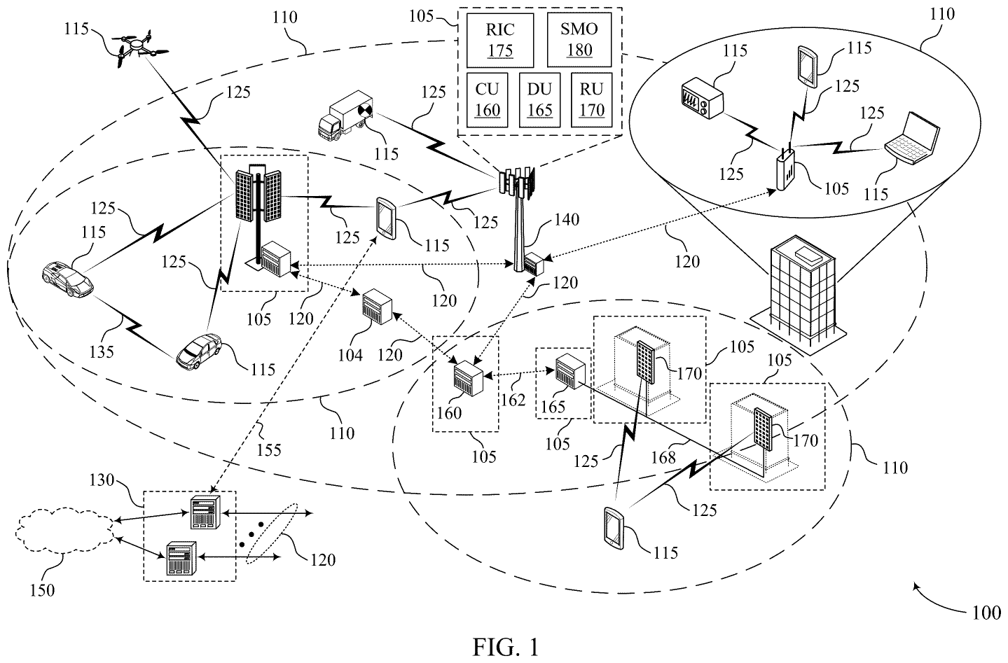

FIG. 1 shows an example of a wireless communications system 100 that supports techniques for configuring a timeline and quantity of downlink control channel decoding candidates in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δ_{f}) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, one or more devices of the wireless communications system 100 may reduce an implementation complexity, lower a power, or both, associated with downlink control channel (e.g., PDCCH) reception. For example, the UE 115 may reduce implementation complexity (e.g., by reducing hardware for receiving PDCCH) or lower power (e.g., by lowering a power state of hardware for receiving PDCCH) based on reducing a quantity of downlink control channel decoding candidates and/or blind decoding attempts over a time duration. For example, the quantity of downlink control channel decoding candidates and/or blind decoding attempts may not exceed a threshold for the time duration. The time duration may be based on (e.g., limited by) a minimum of a downlink control channel search space periodicity or a minimum scheduling offset (e.g., k₀, k₁, and/or k₂). Accordingly, the network entity 105 may configure the downlink control channel search space periodicity, quantity of downlink control channel decoding candidates, downlink control information (DCI) sizes, and minimum scheduling offsets based on a threshold quantity (e.g., constraint) of downlink control channel decoding attempts. For example, the network entity 105 may configure the quantity of downlink control channel decoding candidates such that the quantity of downlink control channel decoding candidates in the minimum of the downlink control channel search space periodicity or the minimum scheduling offset is below a threshold, where the threshold may be specified, configured, and/or subject to a capability of the UE 115. As an example, the network entity 105 may configure the UE 115 with a quantity of downlink control channel decoding candidates (e.g., PDCCH candidates) based on a capability of the UE 115. For example, the UE 115 may indicate downlink processing time durations (e.g., N₁ values) and uplink preparation time durations (e.g., N₂ values) associated with different quantities of PDCCH candidates. Based on the different downlink processing times and uplink preparation times and associated downlink control channel decoding candidates, the network entity 105 may determine one or more time offsets (e.g., minimum time offsets) associated with a quantity of downlink control channel decoding candidates. The network entity 105 may indicate the one or more time offsets and the associated quantity of downlink control channel decoding candidates to the UE 115, and the UE 115 may monitor one or more of the quantity of downlink control channel decoding candidates.

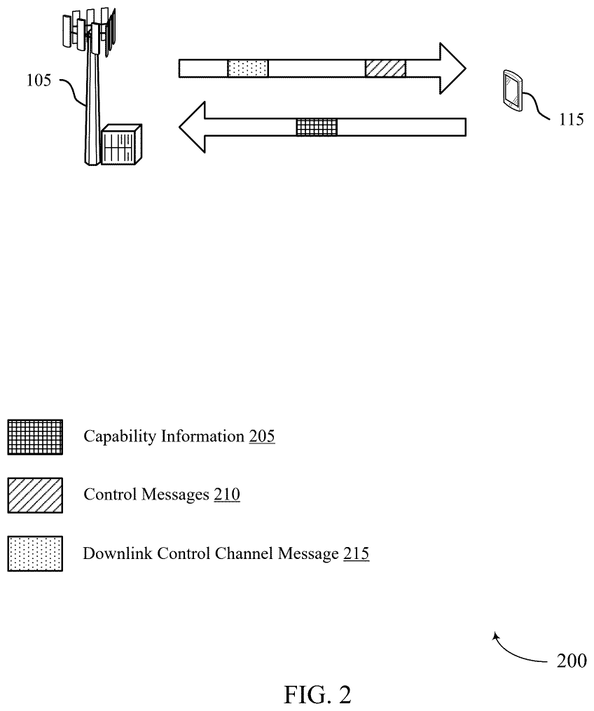

FIG. 2 shows an example of a wireless communications system 200 that supports techniques for configuring a timeline and quantity of downlink control channel decoding candidates in accordance with one or more aspects of the present disclosure. The wireless communications system 200 may implement or be implemented by various aspects of the wireless communications system 100. For example, the wireless communications system 200 may include a network entity 105 and a UE 115, which may represent examples of corresponding devices as illustrated by and described with reference to FIG. 1.

The wireless communications system 200 may support a configurable quantity of downlink control channel decoding candidates (e.g., PDCCH candidates) at UEs, such as the UE 115. For example, the network entity 105 may configure the UE 115 with a quantity of PDCCH candidates and an associated timeline based on a capability of the UE 115.

For example, the UE 115 may transmit capability information 205 to the network entity indicating a capability of the UE 115 to process a PDCCH (e.g., N₁) and prepare a PUSCH (e.g., N₂) associated with different quantities of PDCCH candidates. As an example, the UE 115 may indicate, via the capability information 205, a first PDSCH processing time and a first PUSCH preparation time associated with a first quantity of PDCCH candidates, a second PDSCH processing time and a second PUSCH preparation time associated with a second quantity of PDCCH candidates, and so on. In some examples, the network entity 105 may request that the UE 115 report the capability information 205. For example, the UE 115 may report the capability information 205 in response to a request from the network entity 105.

In some examples, the network entity 105 may indicate different quantities of PDCCH candidates to the UE 115. That is, the UE 115 may report the PDSCH processing times and PUSCH preparation times associated with the different quantities of PDCCH candidates indicated by the network entity 105. Additionally, or alternatively, the UE 115 may request a quantity of PDCCH candidates (e.g., report a preferred quantity of PDCCH candidates) to the network entity 105 via UE assistance information.

In response to the capability information 205, the network entity 105 may indicate multiple time offsets associated with a quantity of PDCCH candidates to the UE 115. For example, the network entity 105 may transmit control messages 210 indicating the multiple time offsets associated with the quantity of PDCCH candidates. The multiple time offsets may be based on the PDSCH processing times and PUSCH preparation times indicated by the UE 115 via the capability information 205. For example, the multiple time offsets may include k₀, k₁, and/or k₂ values calculated by the network entity 105 according to N₁ and N₂ associated with the quantity of PDCCH candidates. That is, the network entity 105 may determine k₁, a quantity of time slots between PDSCH and feedback (e.g., in a PUCCH), to be greater than N₁, the PDSCH processing time. Additionally, the network entity may determine k₂, a quantity of time slots between PDCCH and PUSCH, to be greater than N₂, the PUSCH preparation time. In other words, the network entity 105 may indicate the quantity of PDCCH candidates with an associated communications timeline defined by the multiple time offsets based on PDSCH processing and PUSCH preparation capabilities of the UE 115.

In some examples, the network entity 105 may indicate the multiple time offsets (e.g., minimum time offsets) and associated quantity of PDCCH candidates to the UE 115 via the control messages 210 semi-persistently, such as via RRC messages. For example, the network entity 105 may change a quantity of PDCCH candidates and an associated communications timeline defined by multiple time offsets via an RRC re-configuration.

Additionally, or alternatively, the network entity 105 may indicate multiple sets of time offsets (e.g., minimum time offsets) associated with respective quantities of PDCCH candidates to the UE 115 via the control messages 210. For example, the network entity 105 may indicate first time offsets associated with a first quantity of PDCCH candidates, second time offsets associated with a second quantity of PDCCH candidates, and so on. In some examples, the network entity 105 may configure (e.g., pre-configure) the UE 115 with the multiple sets of time offsets associated with the respective quantities of PDCCH candidates via RRC. Or, the network entity 105 may configure (e.g., pre-configure) the UE 115 with the first time offsets associated with the first quantity of PDCCH candidates (e.g., an initial quantity of PDCCH candidates) and indicate a change to the quantity of PDCCH candidates and the associated communication timeline via a dynamic indication, such as a MAC-control element (MAC-CE) or downlink control information (DCI) message.

For example, the network entity 105 may, after the UE 115 monitors a first quantity of PDCCH candidates, indicate a second quantity of PDCCH candidates via the dynamic indication, such as the DCI message. As an example, the DCI message may indicate which quantity of PDCCH candidates the UE 115 is to monitor based on a quantity of bits. That is, a first bit value may correspond to the first quantity of PDCCH candidates and associated first time offsets, a second bit value may correspond to the second quantity of PDCCH candidates and associated second time offsets (e.g., minimum time offsets), and so on. If the network entity 105 does not indicate the second quantity of PDCCH candidates via the DCI message, the UE 115 may, again, monitor for the first quantity of PDCCH candidates using the first time offsets. That is, the UE 115 may determine that the quantity of PDCCH candidates and the associated time offsets are unchanged by the network entity 105.

Additionally, or alternatively, the UE 115 may switch between one or more states based on receiving the DCI message. For example, the DCI may include one or more bits indicating that the UE 115 is to switch between the one or more states. In some examples, the UE 115 may switch between the one or more states without changing a time domain resource allocation (TDRA) table. For example, each state may be associated with a respective TDRA row of a same TDRA table. That is, the UE 115 may apply a TDRA row restriction in accordance with the state. Additionally, or alternatively, each of the one or more states may be associated with different quantities of PDCCH candidates. For example, the network entity 105 may transmit the DCI to the UE 115 indicating (e.g., via one or more bits) to switch from a first state to a second state. Based on receiving the DCI, the UE 115 may switch from monitoring a first quantity of PDCCH candidates to a second quantity of PDCCH candidates. Additionally, or alternatively, the UE 115 may switch from using a first row of a TDRA table to a second row of the TDRA table based on receiving the DCI.

In some other examples, different quantities of PDCCH candidates may be associated with different TDRA tables. For example, the UE 115 may receive a dynamic indication (e.g., a DCI message or a MAC-CE message) indicating that the UE 115 is to switch to another state. Based on receiving the dynamic indication, the UE 115 may switch both a TDRA table having corresponding time offsets (e.g., minimum time offsets) and an associated quantity of PDCCH candidates. As an example, the UE 115 may receive the dynamic indication and switch from a first TDRA table, a first set of time offsets, and a first quantity of PDCCH candidates to a second TDRA table, a second set of time offsets, and a second quantity of PDCCH candidates.

The UE 115 may, based on the control messages 210, monitor for a downlink control channel message 215, such as a PDCCH. For example, the UE 115 may monitor a quantity of downlink control channel decoding candidates, such as PDCCH candidates, indicated by the control messages 210. In some examples, the UE 115 may decode the downlink control channel message 215. For example, the UE 115 may perform blind decoding over a search space. In some examples, fewer PDCCH candidates may be associated with a shorter time duration associated with blind decoding. In other words, the UE 115 blindly decode PDCCH with fewer PDCCH candidates over less time compared to PDCCH with more PDCCH candidates. Additionally, or alternatively, a complexity of the blind decoding may be reduced for the fewer PDCCH candidates. In other words, the UE 115 may perform blind decoding over the shorter time duration, with reduced complexity, or both for a first quantity of PDCCH candidates than for a second quantity of PDCCH candidates larger than the first quantity of PDCCH candidates.

The network entity 105 may configure the UE 115 with a quantity of PDCCH candidates and corresponding time offsets (e.g., minimum time offsets) based on a PDCCH skipping behavior at the UE 115. For example, the UE may receive the control messages 210 indicating the quantity of PDCCH candidates and an associated set of time offsets, the quantity of PDCCH candidates and the set of time offsets associated with a first PDCCH skipping behavior. For example, the first PDCCH skipping behavior may be to refrain from (e.g., stop) PDCCH monitoring for a time duration X. In some examples, the first PDCCH skipping behavior may be associated with a light traffic load scenario at the UE 115.

In some examples, the network entity 105 may configure the UE 115 with the quantity of PDCCH candidates via the control messages 210, which may be RRC messages. For example, the network entity 105 may indicate the quantity of PDCCH candidates as an absolute value of PDCCH candidates (e.g., a number or quantity of PDCCH candidates), as a difference relative to a second quantity of PDCCH candidates, or as a ratio relative to the second quantity of PDCCH candidates. The second quantity of PDCCH candidates may be associated with a second PDCCH skipping behavior at the UE 115 in which PDCCH skipping is deactivated (e.g., not activated or triggered). That is, the network entity 105 may indicate a difference between the first quantity of PDCCH candidates and the second quantity of PDCCH candidates or a ratio of the first quantity of PDCCH candidates to the second quantity of PDCCH candidates. In some examples, the first quantity of PDCCH candidates may be larger than the second quantity of PDCCH candidates. In other words, the network entity 105 may configure the UE 115 with an increasing quantity of PDCCH candidates when the UE 115 is configured with the first PDCCH skipping behavior (e.g., stopping PDCCH monitoring for the time duration X).

Additionally, or alternatively, the network entity 105 may configure the UE 115 with the quantity of PDCCH candidates and corresponding time offsets (e.g., minimum time offsets) based on a search space set group (SSSG) of the UE 115. For example, the network entity 105 may transmit a switching command to the UE 115 to switch from a first SSSG set to a second SSSG set. Based on transmitting the switching command, the network entity 105 may transmit the control messages 210, such as RRC messages, indicating a second quantity of PDCCH candidates associated with the second SSSG set. That is, the UE 115 may switch from monitoring a first quantity of PDCCH candidates associated with the first SSSG set to the second quantity of PDCCH candidates associated with the second SSSG set based on the switching command and the control messages 210. The network entity 105 may indicate the second quantity of PDCCH candidates as an absolute value of PDCCH candidates (e.g., a number), as a difference relative to the first quantity of PDCCH candidates, or as a ratio relative to the first quantity of PDCCH candidates. In some examples, the first quantity of PDCCH candidates may be larger than or smaller than the second quantity of PDCCH candidates. In other words, the network entity 105 may configure the UE 115 with an increasing or decreasing quantity of PDCCH candidates when the UE 115 is switched between different SSSG sets. Additionally, or alternatively, the network entity 105 may configure the UE 115 with a maximum of the first quantity of PDCCH candidates or the second quantity of PDCCH candidates based on the first SSSG set and the second SSSG set being configured.

In some examples, the UE 115 may use a different row of a TDRA table or a different TDRA table based on receiving the switching command. For example, the first SSSG may be associated with a first row of a TDRA table (e.g., where the first row of the TDRA table may be indicated in the first SSSG) or a first TDRA table while the second SSSG may be associated with a second row of the TDRA table (e.g., where the second row of the TDRA table may be indicated in the second SSSG) or a second TDRA table. In other words, different SSSGs may be associated with different rows of a same table or associated with separate tables. For example, based on receiving the switching command, the UE 115 may switch from the first row of the TDRA table to the second row of the same TDRA table. Or, the UE 115 may switch from the first TDRA table to the second TDRA table.

The UE 115 may refrain from monitoring the indicated quantity of PDCCH candidates in the control messages 210. In other words, the UE 115 may not apply the configured quantity of PDCCH candidates and the associated time offsets (e.g., minimum time offsets). For example, the UE 115 may refrain from monitoring the quantity of PDCCH candidates based on monitoring a search space type, set, or both. As an example, the UE 115 may refrain from monitoring the quantity of PDCCH candidates associated with a group-common search space or common data. In other words, the UE 115 may monitor the quantity of PDCCH candidates based on the quantity of PDCCH candidates being associated with a type of common search space (CSS) (e.g., Type3-CSS), a UE-specific search space (USS), UE-specific data, or any combination thereof. Additionally, or alternatively, the UE 115 may monitor the quantity of PDCCH candidates based on a DCI format (e.g., a DCI format 2_x) or radio network temporary identifier (RNTI). For example, the UE 115 may refrain from monitoring the quantity of PDCCH candidates based on identifying a DCI format for a system information block (SIB), paging, resource allocation (RA), or the like. Additionally, or alternatively, the UE 115 may monitor the quantity of PDCCH candidates based on a type of reference signal. As an example, the UE 115 may refrain from monitoring the quantity of PDCCH candidates for aperiodic sounding reference signals (SRSs), channel state information (CSI)-reference signals (RSs), periodic RSs (PRSs), or the like.

In some examples, the network entity 105 may determine the quantity of PDCCH candidates based on a traffic load at the UE 115. For example, the network entity 105 may transmit the control messages 210 indicating the quantity of PDCCH candidates and an associated set of time offsets based on the traffic load at the UE 115. In a first example, the network entity 105 may indicate a first quantity of PDCCH candidates and an associated first set of time offsets to the UE 115 based on an amount of traffic indicated via a buffer status report (BSR) exceeding a threshold (e.g., a heavy traffic loaded UE). Or, the network entity 105 may indicate a second quantity of PDCCH candidates and an associated second set of time offsets to the UE 115 based on the amount of traffic indicated via the BSR being below the threshold (e.g., a light traffic loaded UE), where the second quantity of PDCCH candidates are less than the first quantity of PDCCH candidates.

In a second example, the network entity 105 may indicate the first quantity of PDCCH candidates and the associated first set of time offsets to the UE 115 based on a quantity of UEs in a cell of the UE 115 exceeding a threshold (e.g., a heavy-loaded cell), a sparse PDCCH blocking probability being greater than a threshold, or both. Or, the network entity 105 may indicate the second quantity of PDCCH candidates and the associated second set of time offsets to the UE 115 based on the quantity of UEs in the cell of the UE 115 being below the threshold (e.g., a light-loaded cell), the sparse PDCCH blocking probability being below the threshold, or both, where the second quantity of PDCCH candidates are less than the first quantity of PDCCH candidates. In other words, the network entity 105 may indicate fewer PDCCH candidates for light-loaded cells compared to heavy-loaded cells.

For example, the wireless communications system 200 may support sparse PDCCH in which the UE 115 monitors PDCCH periodically, such as after Y slots. The network entity 105 may change a periodicity of sparse PDCCH monitoring at the UE 115 via bandwidth part (BWP) switching, SSSG switching, or both. The UE 115 may be blocked within a scheduling window of a PDCCH. For example, the network entity 105, or another device, may refrain from (e.g., or be unable to) schedule the UE 115 on a quantity of resources within a quantity of slots (e.g., X slots) prior to a PDCCH arrival.

In a third example, the network entity 105 may indicate the first quantity of PDCCH candidates and the associated first set of time offsets to the UE 115 based on the UE 115 having delay-sensitive service, a latency requirement greater than a threshold, or both. Or, the network entity 105 may indicate the second quantity of PDCCH candidates and the associated second set of time offsets to the UE 115 based on the UE 115 having delay-tolerant service, a latency requirement less than a threshold, or both, where the second quantity of PDCCH candidates are less than the first quantity of PDCCH candidates. In other words, the network entity 105 may indicate fewer PDCCH candidates for delay-sensitive service compared to delay-tolerant service.

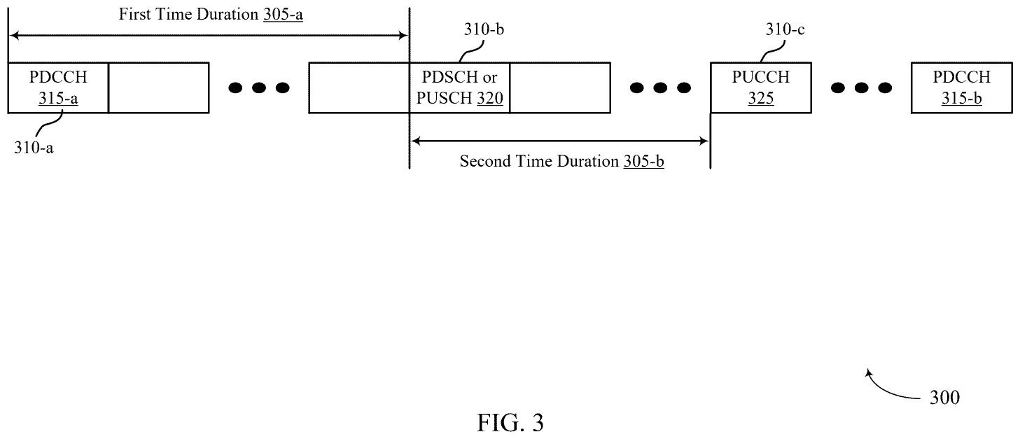

FIG. 3 shows an example of a timing diagram 300 that supports techniques for configuring a timeline and quantity of downlink control channel decoding candidates in accordance with one or more aspects of the present disclosure. The timing diagram 300 may implement or be implemented by various aspects of the wireless communications system 100, the wireless communications system 200, or both. For example, the timing diagram 300 may be implemented by a network entity and a UE, which may represent examples of corresponding devices as illustrated by and described with reference to FIGS. 1 and 2.

In the example of FIG. 3, the UE and the network entity may exchange signals according to a timing diagram 300 including a first time duration 305-a and a second time duration 305-b. The first time duration 305-a may denote a time duration between a first slot 310-a in which a PDCCH 315-a is communicated (e.g., transmitted by the network entity to the UE) and a second slot 310-b in which a PDSCH or PUSCH 320 is communicated (e.g., transmitted by the network entity to the UE or transmitted by the UE to the network entity). The second time duration 305-b may denote a second time duration between the second slot 310-b in which the PDSCH or PUSCH 320 is communicated and a third slot 310-c in which a PUCCH 325 is communicated (e.g., transmitted by the UE to the network entity).

The UE may monitor for the PDCCH 315-a and a PDCCH 315-b in one or more downlink control channel decoding candidates, such as PDCCH candidates. In some examples, the UE 115 may receive an indication, such as via control signaling (e.g., the control messages 210 as described with reference to FIG. 2), of a quantity of downlink decoding candidates to be monitored. In the example of FIG. 3, the UE may monitor one or more first PDCCH candidates associated with the PDCCH 315-a, one or more second PDCCH candidates associated with the PDCCH 315-b, or both based on the indication of the quantity of PDCCH candidates. In some examples, the UE may monitor for multiple PDCCH candidates in a PDCCH occasion, which may correspond to the PDCCH 315-a, the PDCCH 315-b, or both. The UE may blindly decode the PDCCH 315-a, the PDCCH 315-b, or both. That is, the UE may blindly decode the PDCCH 315-a associated with the one or more first PDCCH candidates, the PDCCH 315-b associated with the one or more second PDCCH candidates, or both based on the indication of the quantity of PDCCH candidates.

For example, to blindly decode the PDCCH 315-a, the PDCCH 315-b, or both, the UE may monitor CORESETs (e.g., all CORESETs) associated with the PDCCH 315-a, the PDCCH 315-b, or both. Additionally, or alternatively, the UE may monitor for the PDCCH 315-a, the PDCCH 315-b, or both in sets of resource element groups (REGs) of one or more ALs. For example, a network entity may group REGs into control channel elements (CCEs), which may then be further aggregated into ALs. For example, a lowest AL may include a single CCE, and a higher AL may include two, four, eight, or more CCEs.

The UE may monitor for PDCCH messages, such as DCIs, during each subframe of the PDCCH 315-a, the PDCCH 315-b, or both in combinations of the CORESETs, the REGs, and the ALs of the PDCCH 315-a, the PDCCH 315-b, or both. The UE may, in each candidate (e.g., the one or more first PDCCH candidates, the one or more second PDCCH candidates, or both), attempt to decode the PDCCH messages. For example, the UE may demodulate, descramble, and decode the PDCCH messages (e.g., according to a DCI format). In some examples, the UE may perform a cyclic redundancy check (CRC) and determine whether the PDCCH messages are for the UE according to an identifier, such as an RNTI.

The control signaling may also indicate a communications timeline associated with the quantity of PDCCH candidates. For example, the control signaling may indicate the first time duration 305-a, the second time duration 305-b, or both associated with the quantity of PDCCH candidates. That is, the timing diagram 300 may correspond to the communications timeline associated with the quantity of PDCCH candidates indicated via the control signaling.

The network entity may determine the communications timeline, including the first time duration 305-a and the second time duration 305-b, based on a capability of the UE (e.g., the capability information 205 as described with reference to FIG. 2). For example, the first time duration 305-a, the second time duration 305-b, or both may be based on N₁, the PDSCH processing time at the UE; N₂, the PUSCH preparation time at the UE; or both. For example, the network entity may determine the first time duration 305-a, which may be based on k₂, a quantity of time slots between the PDCCH 315-a and PUSCH (e.g., of the PDSCH or PUSCH 320), to be greater than N₂. In some examples, the network entity may determine the first time duration 305-a, which may be based on k₀, a quantity of time slots between the PDCCH 315-a and PDSCH (e.g., of the PDSCH or PUSCH 320), based on N₁, N₂, or both. Additionally, or alternatively, the network entity may determine the second time duration 305-b, which may be based on k₁, a quantity of time slots between PDSCH (e.g., of the PDSCH or PUSCH 320) and feedback (e.g., in the PUCCH 325), to be greater than N₁.

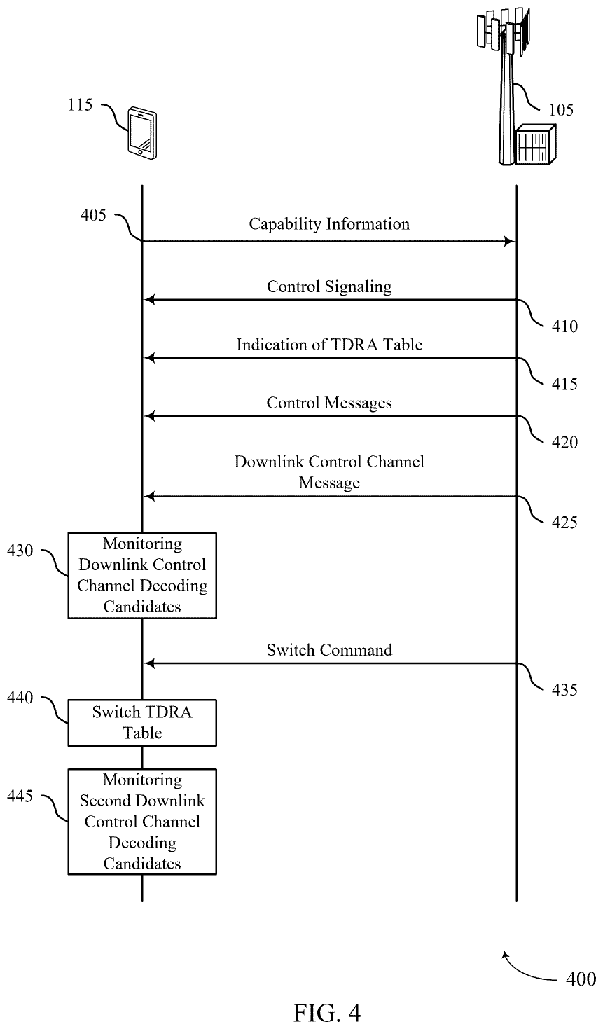

FIG. 4 shows an example of a process flow 400 that supports techniques for configuring a timeline and quantity of downlink control channel decoding candidates in accordance with one or more aspects of the present disclosure. In some examples, the process flow 400 may implement or be implemented by aspects of the wireless communications system 100, the wireless communications system 200, and the timing diagram 300 as described with reference to FIGS. 1-3. For example, the process flow 400 may include a network entity 105 and a UE 115, which may be examples of corresponding devices as illustrated by and described with reference to FIGS. 1 and 2.

Alternative examples of the following may be implemented. Some steps are performed in a different order than described or are not performed at all. In some cases, steps may include additional features not mentioned below, or further steps may be added. Although the network entity 105 and the UE 115 are shown performing the operations of the process flow 400, some aspects of some operations may also be performed by one or more other wireless communication devices.

At 405, the UE 115 may transmit capability information to the network entity 105. The capability information may be an example of the capability information 205 as described with reference to FIG. 2. For example, the UE 115 may transmit, to the network entity 105, capability information indicating a first downlink processing time duration (e.g., N₁, the PDSCH processing time) and a first uplink preparation time duration (e.g., N₂, the PUSCH preparation time) associated with a first quantity of downlink control channel decoding candidates and a second downlink processing time duration (e.g., N₁) and a second uplink preparation time duration (e.g., N₂) associated with a second quantity of downlink control channel decoding candidates.

At 410, the network entity 105 may transmit control signaling to the UE 115. For example, the UE 115 may receive control signaling deactivating downlink control channel skipping.

At 415, the network entity 105 may transmit an indication of a TDRA table to the UE 115. For example, the UE 115 may receive, from the network entity 105, an indication of a first row of a TDRA table associated with a first SSSG and a second row of the TDRA table associated with a second SSSG.

At 420, the network entity 105 may transmit one or more control messages to the UE 115. The one or more control messages may be an example of the control messages 210 as described with reference to FIG. 2. For example, the UE 115 may receive, based on the capability information, the one or more control messages indicating a set of multiple of time offsets associated with a third quantity of downlink control channel decoding candidates. The third quantity of downlink control channel decoding candidates may be one of the first quantity of downlink control channel decoding candidates or the second quantity of downlink control channel decoding candidates, and the set of multiple time offsets may be based on one of the first downlink processing time duration and the first uplink preparation time duration (e.g., N₁ and N₂ associated with the first quantity of downlink control channel decoding candidates) or the second downlink processing time duration and the second uplink preparation time duration (e.g., N₁ and N₂ associated with the second quantity of downlink control channel decoding candidates).

The set of multiple time offsets may include k₀, k₁, k₂, or any combination thereof. The set of multiple time offsets may include a first slot duration, a second slot duration, or both, such as the first time duration 305-a, the second time duration 305-b, or both as described with reference to FIG. 3. For example, the set of multiple time offsets may include a first time offset (e.g., k₀) including a first time duration between a downlink control channel (e.g., PDCCH, such as the PDCCH 315-a as described with reference to FIG. 3) and a downlink shared data channel (e.g., PDSCH, such as the PDSCH or PUSCH 320 as described with reference to FIG. 3) corresponding to (e.g., scheduled by) the downlink control channel. Additionally, or alternatively, the set of multiple time offsets may include a second time offset (e.g., k₂) including a second time duration between the downlink control channel (e.g., PDCCH) and an uplink shared data channel (e.g., PUSCH, such as the PDSCH or PUSCH 320 as described with reference to FIG. 3). In some examples, the set of multiple time offsets may include a third time offset (e.g., k₁) including a third time duration between the downlink shared data channel (e.g., PDSCH) and a feedback channel (e.g., ACK/NACK in PUCCH, such as the PUCCH 325 as described with reference to FIG. 3).

The one or more control messages at 420 may further indicate a second set of multiple time offsets associated with a fourth quantity of downlink control channel candidates. For example, the network entity 105 may configure (e.g., pre-configure, such as via RRC), multiple sets of downlink control channel decoding candidates and associated sets of multiple time offsets. In some examples, the set of multiple time offsets may be associated with the first SSSG and the second set of multiple time offsets is associated with the second SSSG.

The third quantity of downlink control channel decoding candidates may include the first quantity of downlink control channel decoding candidates, and the set of multiple time offsets may be based on the first downlink processing time duration and the first uplink preparation time duration. The fourth quantity of downlink control channel decoding candidates may include the second quantity of downlink control channel decoding candidates, and the second set of multiple time offsets may be based on the second downlink processing time duration and the second uplink preparation time duration. For example, the one or more control messages may be RRC messages indicating to monitor one of the first quantity of downlink control channel decoding candidates or the second quantity of downlink control channel decoding candidates.

Additionally, or alternatively, the one or more control messages may be a DCI indicating to monitor one of the first quantity of downlink control channel decoding candidates or the second quantity of downlink control channel decoding candidates. For example, the network entity 105 may configure the first quantity of downlink control channel decoding candidates and the second quantity of downlink control channel decoding candidates prior to transmitting the DCI. That is, the network entity 105 may transmit the DCI to dynamically indicate a next quantity of downlink control channel decoding candidates to monitor after initially configuring a quantity of downlink control channel candidates (e.g., via RRC).

In some examples, the one or more control messages may indicate the set of multiple of time offsets associated with the third quantity of downlink control channel decoding candidates may be based on the control signaling deactivating the downlink control channel skipping at 410. For example, the third quantity of downlink control channel decoding candidates may include one of a quantity of the third quantity of downlink control channel decoding candidates, a difference between the third quantity of downlink control channel decoding candidates and a fourth quantity of downlink control channel decoding candidates when the downlink control channel skipping is deactivated, or a difference between the third quantity of downlink control channel decoding candidates and a fourth quantity of downlink control channel decoding candidates when the downlink control channel skipping is deactivated.

The one or more control messages may be one or more semi-persistent RRC messages. That is, the network entity 105 may indicate the third quantity of downlink control channel decoding candidates and the associated set of multiple time offsets semi-persistently via RRC messages.

In some examples, the third quantity of downlink control channel decoding candidates associated with the set of multiple time offsets may be based on an amount of traffic of the UE 115 satisfying a first threshold, an active quantity of UEs communicating with a cell serving the UE 115 satisfying a second threshold, a delay sensitivity associated with providing service satisfying a third threshold, or a combination thereof.

At 425, the network entity 105 may transmit a downlink control channel message to the UE 115. The downlink control channel message may be an example of the downlink control channel message 215 as described with reference to FIG. 2. At 430, the UE 115 may monitor downlink control channel decoding candidates. For example, the UE 115 may monitor one or more downlink control channel decoding candidates of the third quantity of downlink control channel decoding candidates based on the one or more control messages received at 420.

In some examples, the UE 115 may refrain from monitoring the one or more downlink control channel decoding candidates of the third quantity of downlink control channel decoding candidates based on one or more of a type of search space set being monitored by the UE 115, a DCI format of the one or more control messages at 420 indicating the third quantity of downlink control channel decoding candidates, a RNTI of the one or more control messages indicating the third quantity of downlink control channel decoding candidates, a reference signal type of one or more reference signals scheduled to be received by the UE 115 via the one or more downlink control channel decoding candidates, or any combination thereof.

At 435, the network entity 105 may transmit a switch command to the UE 115. For example, the UE 226 may receive the switch command indicating to switch from the first SSSG to the second SSSG. In response to receiving the switch command, at 440, the UE 115 may switch a TDRA table. For example, the UE 115 may switch, based on the switch command received at 435, from a first TDRA table associated with the first SSSG to a second TDRA table associated with the second SSSG.

At 445, the UE 115 may monitor second downlink control channel decoding candidates. For example, the UE 115 may monitor one or more second downlink control channel decoding candidates of the fourth quantity of downlink control channel decoding candidates in accordance with the second row of the TDRA table based on the switch command received at 435. Alternatively, the UE 115 may monitor one or more second downlink control channel decoding candidates of the fourth quantity of downlink control channel decoding candidates in accordance with the second TDRA table based on the switch command received at 435.

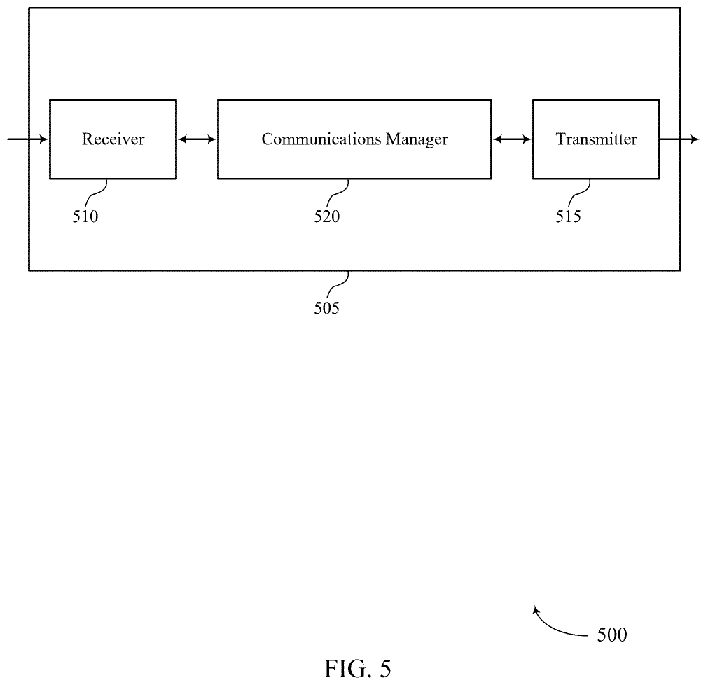

FIG. 5 shows a block diagram 500 of a device 505 that supports techniques for configuring a timeline and quantity of downlink control channel decoding candidates in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for configuring a timeline and quantity of downlink control channel decoding candidates). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for configuring a timeline and quantity of downlink control channel decoding candidates). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for configuring a timeline and quantity of downlink control channel decoding candidates as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The communications manager 520 is capable of, configured to, or operable to support a means for receiving, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration. The communications manager 520 is capable of, configured to, or operable to support a means for monitoring one or more downlink control channel decoding candidates of the third quantity of downlink control channel decoding candidates based on the one or more control messages.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources.

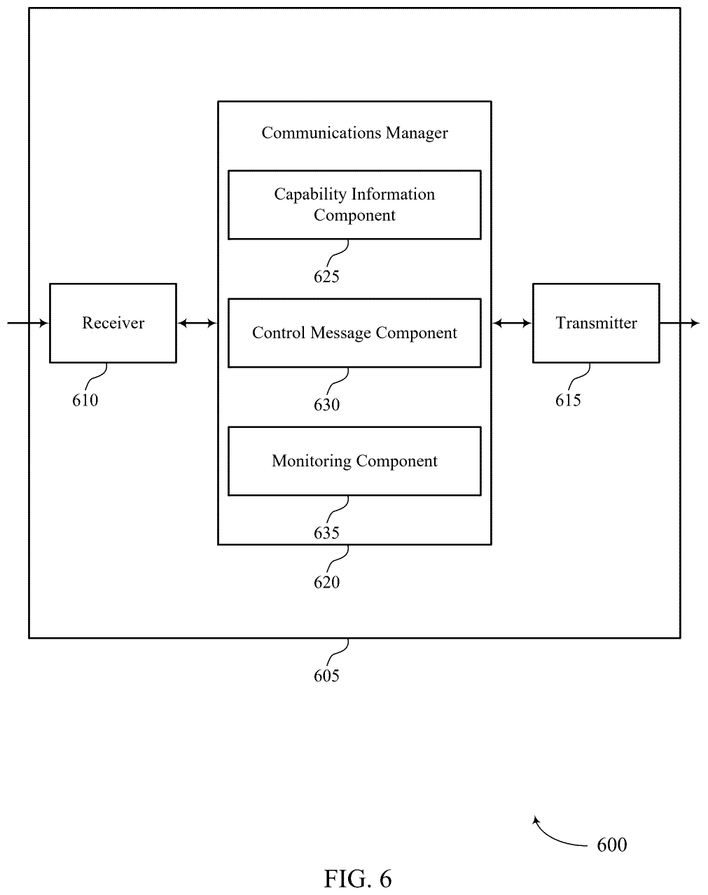

FIG. 6 shows a block diagram 600 of a device 605 that supports techniques for configuring a timeline and quantity of downlink control channel decoding candidates in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for configuring a timeline and quantity of downlink control channel decoding candidates). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for configuring a timeline and quantity of downlink control channel decoding candidates). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for configuring a timeline and quantity of downlink control channel decoding candidates as described herein. For example, the communications manager 620 may include a capability information component 625, a control message component 630, a monitoring component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The capability information component 625 is capable of, configured to, or operable to support a means for transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The control message component 630 is capable of, configured to, or operable to support a means for receiving, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration. The monitoring component 635 is capable of, configured to, or operable to support a means for monitoring one or more downlink control channel decoding candidates of the third quantity of downlink control channel decoding candidates based on the one or more control messages.

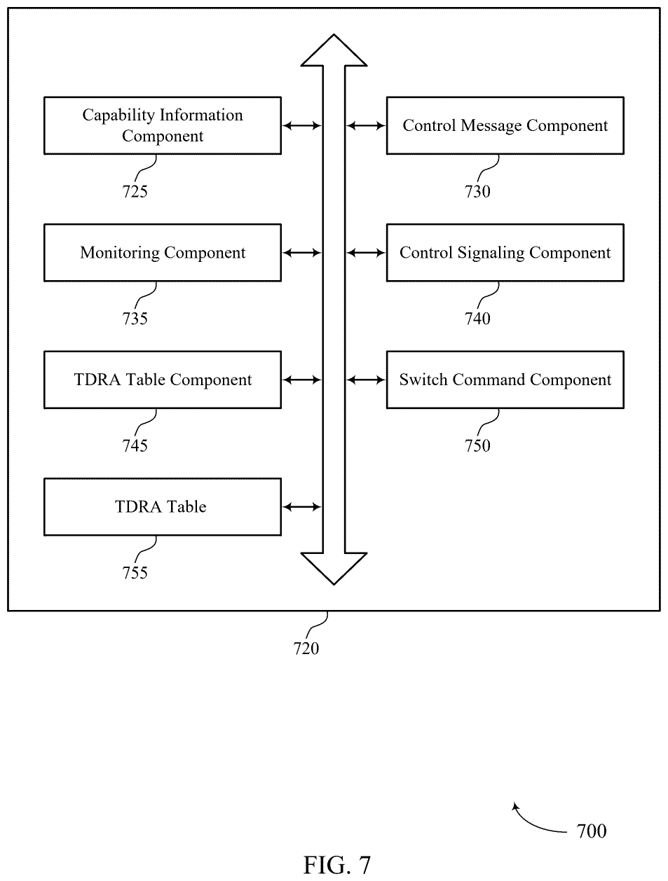

FIG. 7 shows a block diagram 700 of a communications manager 720 that supports techniques for configuring a timeline and quantity of downlink control channel decoding candidates in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for configuring a timeline and quantity of downlink control channel decoding candidates as described herein. For example, the communications manager 720 may include a capability information component 725, a control message component 730, a monitoring component 735, a control signaling component 740, a TDRA table component 745, a switch command component 750, a TDRA table 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The capability information component 725 is capable of, configured to, or operable to support a means for transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The control message component 730 is capable of, configured to, or operable to support a means for receiving, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration. The monitoring component 735 is capable of, configured to, or operable to support a means for monitoring one or more downlink control channel decoding candidates of the third quantity of downlink control channel decoding candidates based on the one or more control messages.

In some examples, a first time duration between a downlink control channel and a downlink shared data channel corresponding to the downlink control channel. In some examples, a second time duration between the downlink control channel and an uplink shared data channel. In some examples, a third time duration between the downlink shared data channel and a feedback channel.

In some examples, to support receiving the one or more control messages, the control message component 730 is capable of, configured to, or operable to support a means for receiving the one or more control messages further indicating a second set of multiple time offsets associated with a fourth quantity of downlink control channel decoding candidates, where the third quantity of downlink control channel decoding candidates includes the first quantity of downlink control channel decoding candidates, the fourth quantity of downlink control channel decoding candidates includes the second quantity of downlink control channel decoding candidates, the set of multiple time offsets are based on the first downlink processing time duration and the first uplink preparation time duration, the second set of multiple time offsets are based on the second downlink processing time duration and the second uplink preparation time duration, and the one or more control messages include one or more RRC messages indicating to monitor one of the first quantity of downlink control channel decoding candidates or the second quantity of downlink control channel decoding candidates.

In some examples, to support receiving the one or more control messages, the control message component 730 is capable of, configured to, or operable to support a means for receiving downlink control information indicating to monitor one of the first quantity of downlink control channel decoding candidates or the second quantity of downlink control channel decoding candidates.

In some examples, receiving control signaling deactivating downlink control channel skipping, where the third quantity of downlink control channel decoding candidates include at least one of. In some examples, a quantity of the third quantity of downlink control channel decoding candidates. In some examples, a difference between the third quantity of downlink control channel decoding candidates and a fourth quantity of downlink control channel decoding candidates when the downlink control channel skipping is deactivated. In some examples, a ratio of the third quantity of downlink control channel decoding candidates and the fourth quantity of downlink control channel decoding candidates.

In some examples, to support receiving the one or more control messages, the control message component 730 is capable of, configured to, or operable to support a means for receiving the one or more control messages indicating the set of multiple time offsets associated with the third quantity of downlink control channel decoding candidates and a second set of multiple time offsets associated with a fourth quantity of downlink control channel decoding candidates, where the set of multiple time offsets is associated with a first search space set group (SSSG) and the second set of multiple time offsets is associated with a second SSSG.

In some examples, the TDRA table component 745 is capable of, configured to, or operable to support a means for receiving, from the network entity, an indication of a first row of a time domain resource allocation (TDRA) table associated with the first SSSG and a second row of the TDRA table associated with the second SSSG. In some examples, the switch command component 750 is capable of, configured to, or operable to support a means for receiving a switch command indicating to switch from the first SSSG to the second SSSG. In some examples, the monitoring component 735 is capable of, configured to, or operable to support a means for monitoring one or more second downlink control channel decoding candidates of the fourth quantity of downlink control channel decoding candidates in accordance with the second row of the TDRA table based on the switch command.

In some examples, the switch command component 750 is capable of, configured to, or operable to support a means for receiving, from the network entity, a switch command indicating to switch from the first SSSG to the second SSSG. In some examples, the TDRA table 755 is capable of, configured to, or operable to support a means for switching, based on the indication, from a first time domain resource allocation (TDRA) table associated with the first SSSG to a second TDRA associated with the second SSSG.

In some examples, the one or more control messages include one or more semi-persistent RRC messages.

In some examples, the monitoring component 735 is capable of, configured to, or operable to support a means for refraining from monitoring the one or more downlink control channel decoding candidates of the third quantity of downlink control channel decoding candidates based on one or more of a type of search space set being monitored by the UE, a DCI format of the one or more control messages indicating the third quantity of downlink control channel decoding candidates, a radio network temporary identifier (RNTI) of the one or more control messages indicating the third quantity of downlink control channel decoding candidates, a reference signal type of one or more reference signals scheduled to be received by the UE via the one or more downlink control channel decoding candidates, or any combination thereof.

In some examples, the third quantity of downlink control channel decoding candidates associated with the set of multiple time offsets are based on an amount of traffic of the UE satisfying a first threshold, an active number of UEs communicating with a cell serving the UE satisfying a second threshold, a delay sensitivity associated with providing service satisfying a third threshold, or a combination thereof.

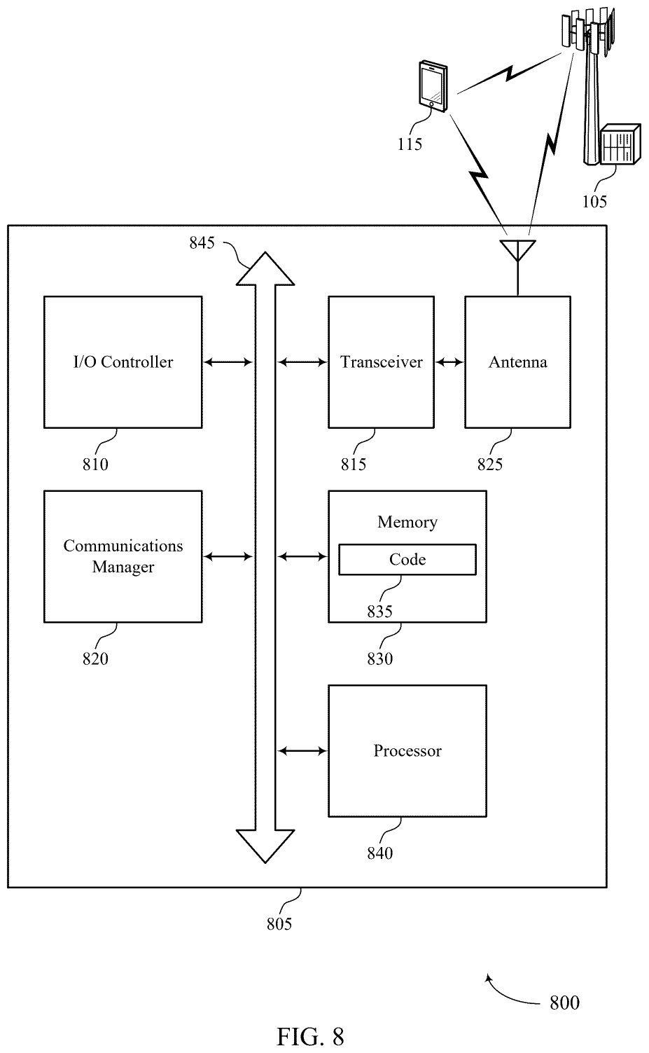

FIG. 8 shows a diagram of a system 800 including a device 805 that supports techniques for configuring a timeline and quantity of downlink control channel decoding candidates in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for configuring a timeline and quantity of downlink control channel decoding candidates). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The communications manager 820 is capable of, configured to, or operable to support a means for receiving, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration. The communications manager 820 is capable of, configured to, or operable to support a means for monitoring one or more downlink control channel decoding candidates of the third quantity of downlink control channel decoding candidates based on the one or more control messages.

By including or configuring the communications manager 820 in accordance with examples as described herein, the device 805 may support techniques for reduced power consumption and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for configuring a timeline and quantity of downlink control channel decoding candidates as described herein, or the at least one processor 840 and the at least one memory 830 may be otherwise configured to, individually or collectively, perform or support such operations.

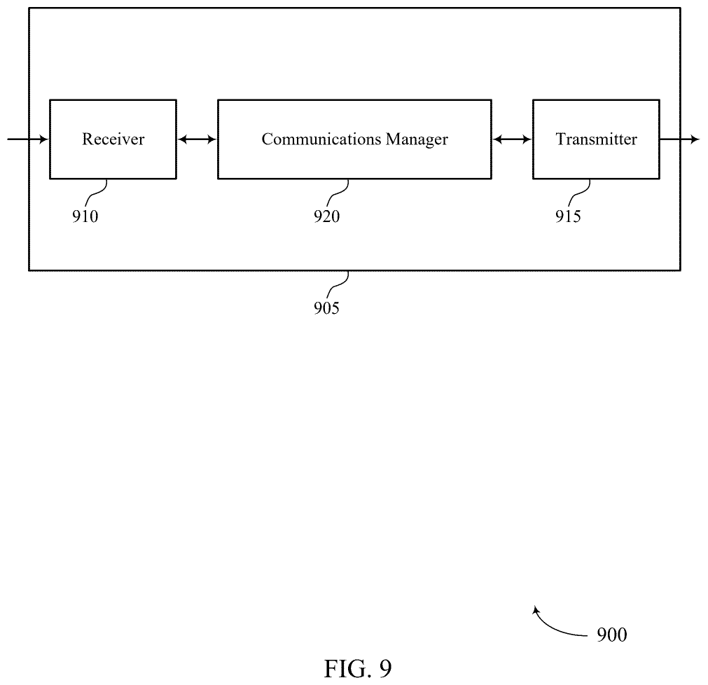

FIG. 9 shows a block diagram 900 of a device 905 that supports techniques for configuring a timeline and quantity of downlink control channel decoding candidates in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for configuring a timeline and quantity of downlink control channel decoding candidates as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The communications manager 920 is capable of, configured to, or operable to support a means for transmitting, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration. The communications manager 920 is capable of, configured to, or operable to support a means for transmitting a downlink control channel message based on the one or more control messages.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption and more efficient utilization of communication resources.

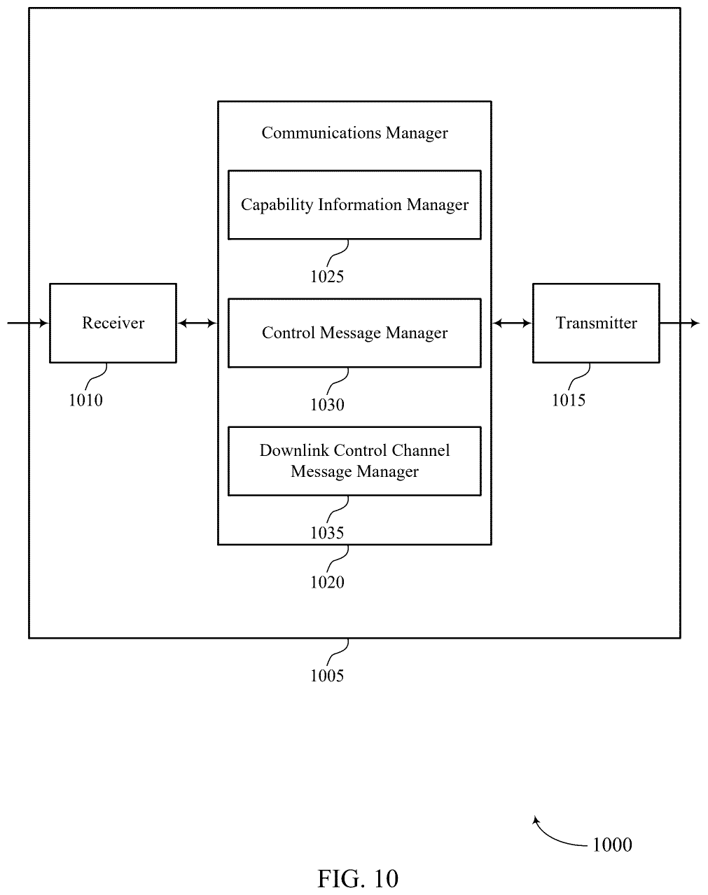

FIG. 10 shows a block diagram 1000 of a device 1005 that supports techniques for configuring a timeline and quantity of downlink control channel decoding candidates in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for configuring a timeline and quantity of downlink control channel decoding candidates as described herein. For example, the communications manager 1020 may include a capability information manager 1025, a control message manager 1030, a downlink control channel message manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The capability information manager 1025 is capable of, configured to, or operable to support a means for receiving, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The control message manager 1030 is capable of, configured to, or operable to support a means for transmitting, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration. The downlink control channel message manager 1035 is capable of, configured to, or operable to support a means for transmitting a downlink control channel message based on the one or more control messages.

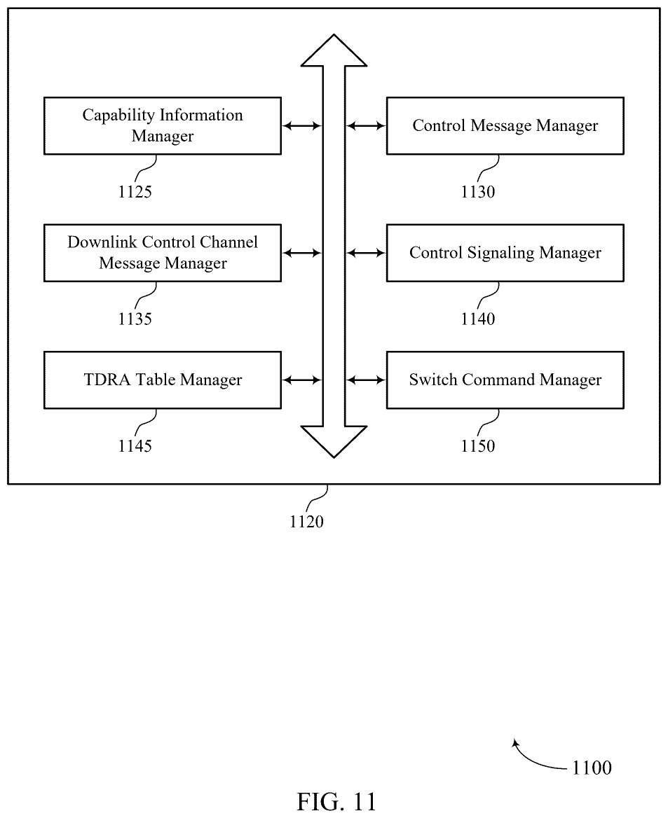

FIG. 11 shows a block diagram 1100 of a communications manager 1120 that supports techniques for configuring a timeline and quantity of downlink control channel decoding candidates in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for configuring a timeline and quantity of downlink control channel decoding candidates as described herein. For example, the communications manager 1120 may include a capability information manager 1125, a control message manager 1130, a downlink control channel message manager 1135, a control signaling manager 1140, a TDRA table manager 1145, a switch command manager 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The capability information manager 1125 is capable of, configured to, or operable to support a means for receiving, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The control message manager 1130 is capable of, configured to, or operable to support a means for transmitting, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration. The downlink control channel message manager 1135 is capable of, configured to, or operable to support a means for transmitting a downlink control channel message based on the one or more control messages.

In some examples, a first time duration between a downlink control channel and a downlink shared data channel corresponding to the downlink control channel. In some examples, a second time duration between the downlink control channel and an uplink shared data channel. In some examples, a third time duration between the downlink shared data channel and a feedback channel.

In some examples, to support transmitting the one or more control messages, the control message manager 1130 is capable of, configured to, or operable to support a means for transmitting the one or more control messages further indicating a second set of multiple time offsets associated with a fourth quantity of downlink control channel decoding candidates, where the third quantity of downlink control channel decoding candidates includes the first quantity of downlink control channel decoding candidates, the fourth quantity of downlink control channel decoding candidates includes the second quantity of downlink control channel decoding candidates, the set of multiple time offsets are based on the first downlink processing time duration and the first uplink preparation time duration, the second set of multiple time offsets are based on the second downlink processing time duration and the second uplink preparation time duration, and the one or more control messages include one or more RRC messages indicating to monitor one of the first quantity of downlink control channel decoding candidates or the second quantity of downlink control channel decoding candidates.

In some examples, to support transmitting the one or more control messages, the control message manager 1130 is capable of, configured to, or operable to support a means for transmitting downlink control information indicating to monitor one of the first quantity of downlink control channel decoding candidates or the second quantity of downlink control channel decoding candidates.

In some examples, transmitting control signaling deactivating downlink control channel skipping at the UE, where the third quantity of downlink control channel decoding candidates include at least one of. In some examples, a quantity of the third quantity of downlink control channel decoding candidates. In some examples, a difference between the third quantity of downlink control channel decoding candidates and a fourth quantity of downlink control channel decoding candidates when the downlink control channel skipping is deactivated. In some examples, a ratio of the third quantity of downlink control channel decoding candidates and the fourth quantity of downlink control channel decoding candidates.

In some examples, to support transmitting the one or more control messages, the control message manager 1130 is capable of, configured to, or operable to support a means for transmitting the one or more control messages indicating the set of multiple time offsets associated with the third quantity of downlink control channel decoding candidates and a second set of multiple time offsets associated with a fourth quantity of downlink control channel decoding candidates, where the set of multiple time offsets is associated with a first search space set group (SSSG) and the second set of multiple time offsets is associated with a second SSSG.

In some examples, the TDRA table manager 1145 is capable of, configured to, or operable to support a means for transmitting an indication of a first row of a time domain resource allocation (TDRA) table associated with the first SSSG and a second row of the TDRA table associated with the second SSSG. In some examples, the switch command manager 1150 is capable of, configured to, or operable to support a means for transmitting a switch command indicating to switch from the first SSSG to the second SSSG, where the UE is to monitor one or more second downlink control channel decoding candidates of the fourth quantity of downlink control channel decoding candidates in accordance with the second row of the TDRA table based on the switch command.

In some examples, the switch command manager 1150 is capable of, configured to, or operable to support a means for transmitting, to the UE, a switch command indicating to switch from the first SSSG to the second SSSG, where the UE is to switch from a first time domain resource allocation (TDRA) table associated with the first SSSG to a second TDRA associated with the second SSSG.

In some examples, the one or more control messages include one or more semi-persistent RRC messages.

In some examples, the third quantity of downlink control channel decoding candidates associated with the set of multiple time offsets are based on an amount of traffic of the UE satisfying a first threshold, an active quantity of UEs communicating with a cell serving the UE satisfying a second threshold, a delay sensitivity associated with providing service satisfying a third threshold, or a combination thereof.

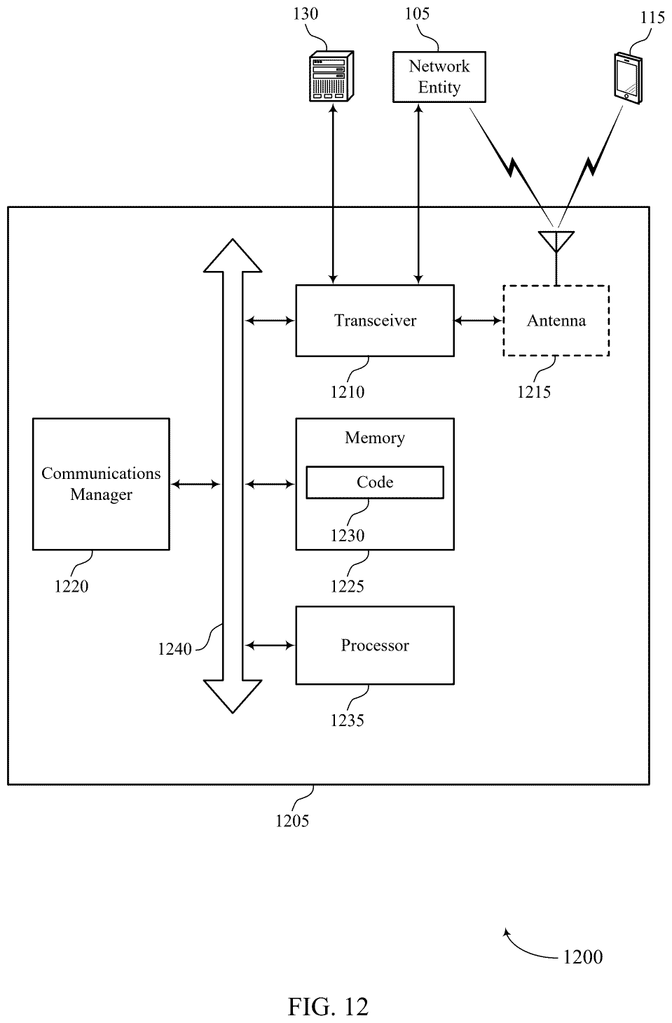

FIG. 12 shows a diagram of a system 1200 including a device 1205 that supports techniques for configuring a timeline and quantity of downlink control channel decoding candidates in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for configuring a timeline and quantity of downlink control channel decoding candidates). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The communications manager 1220 is capable of, configured to, or operable to support a means for transmitting, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration. The communications manager 1220 is capable of, configured to, or operable to support a means for transmitting a downlink control channel message based on the one or more control messages.

By including or configuring the communications manager 1220 in accordance with examples as described herein, the device 1205 may support techniques for reduced power consumption and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for configuring a timeline and quantity of downlink control channel decoding candidates as described herein, or the at least one processor 1235 and the at least one memory 1225 may be otherwise configured to, individually or collectively, perform or support such operations.

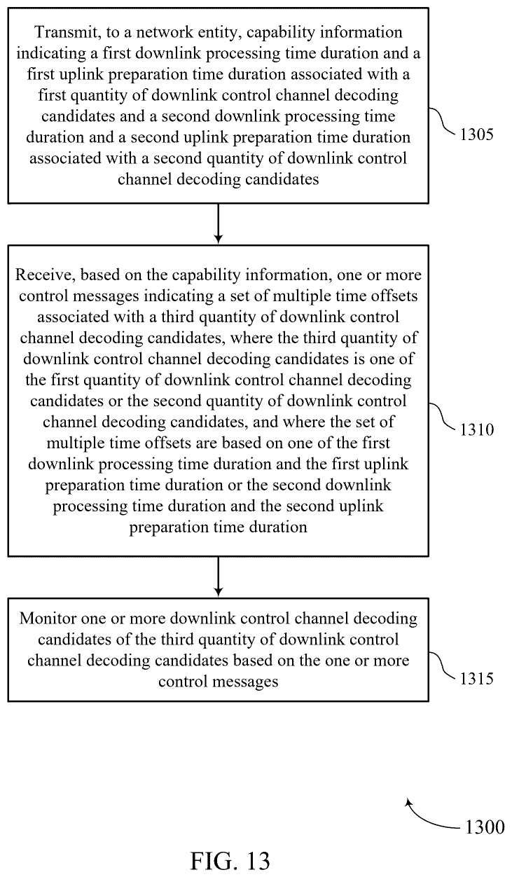

FIG. 13 shows a flowchart illustrating a method 1300 that supports techniques for configuring a timeline and quantity of downlink control channel decoding candidates in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The operations of 1305 may be performed in accordance with examples as disclosed herein. In some examples, aspects of the operations of 1305 may be performed by a capability information component 725 as described with reference to FIG. 7.

At 1310, the method may include receiving, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration. The operations of 1310 may be performed in accordance with examples as disclosed herein. In some examples, aspects of the operations of 1310 may be performed by a control message component 730 as described with reference to FIG. 7.

At 1315, the method may include monitoring one or more downlink control channel decoding candidates of the third quantity of downlink control channel decoding candidates based on the one or more control messages. The operations of 1315 may be performed in accordance with examples as disclosed herein. In some examples, aspects of the operations of 1315 may be performed by a monitoring component 735 as described with reference to FIG. 7.

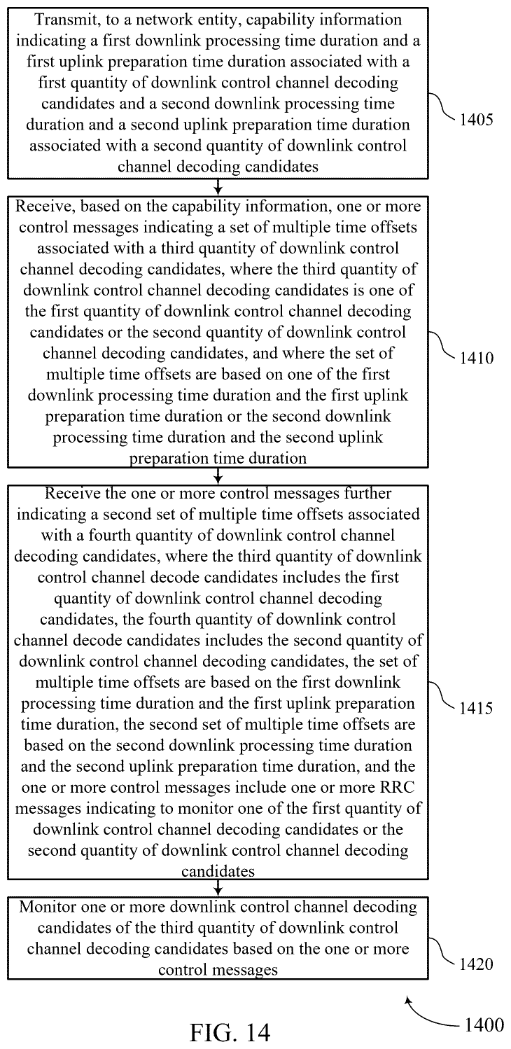

FIG. 14 shows a flowchart illustrating a method 1400 that supports techniques for configuring a timeline and quantity of downlink control channel decoding candidates in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The operations of 14105 may be performed in accordance with examples as disclosed herein. In some examples, aspects of the operations of 1410 may be performed by a capability information component 725 as described with reference to FIG. 7.

At 1410, the method may include receiving, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or the second downlink processing time duration and the second uplink preparation time duration. The operations of 1410 may be performed in accordance with examples as disclosed herein. In some examples, aspects of the operations of 1410 may be performed by a control message component 730 as described with reference to FIG. 7.

At 1415, the method may include receiving the one or more control messages further indicating a second set of multiple time offsets associated with a fourth quantity of downlink control channel decoding candidates, where the third quantity of downlink control channel decoding candidates includes the first quantity of downlink control channel decoding candidates, the fourth quantity of downlink control channel decoding candidates includes the second quantity of downlink control channel decoding candidates, the set of multiple time offsets are based on the first downlink processing time duration and the first uplink preparation time duration, the second set of multiple time offsets are based on the second downlink processing time duration and the second uplink preparation time duration, and the one or more control messages include one or more RRC messages indicating to monitor one of the first quantity of downlink control channel decoding candidates or the second quantity of downlink control channel decoding candidates. The operations of 1405 may be performed in accordance with examples as disclosed herein. In some examples, aspects of the operations of 1405 may be performed by a control message component 730 as described with reference to FIG. 7.

At 1420, the method may include monitoring one or more downlink control channel decoding candidates of the third quantity of downlink control channel decoding candidates based on the one or more control messages. The operations of 1420 may be performed in accordance with examples as disclosed herein. In some examples, aspects of the operations of 1420 may be performed by a monitoring component 735 as described with reference to FIG. 7.

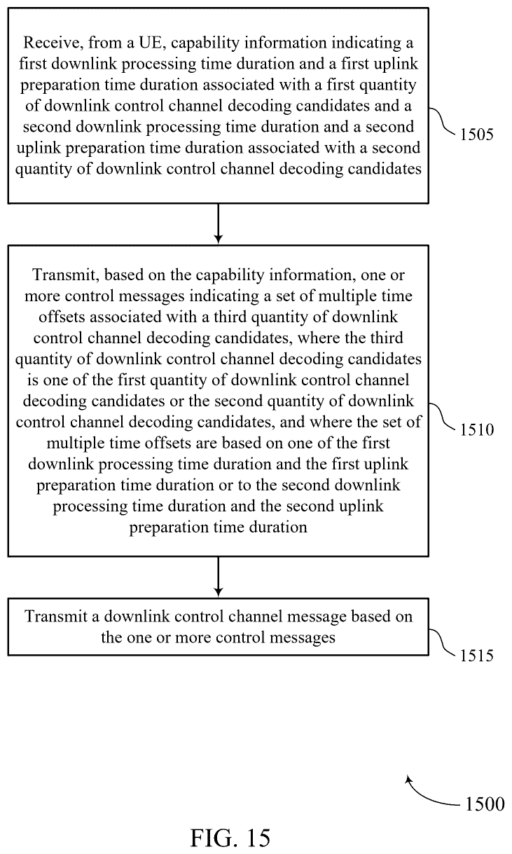

FIG. 15 shows a flowchart illustrating a method 1500 that supports techniques for configuring a timeline and quantity of downlink control channel decoding candidates in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The operations of 1505 may be performed in accordance with examples as disclosed herein. In some examples, aspects of the operations of 1505 may be performed by a capability information manager 1125 as described with reference to FIG. 11.

At 1510, the method may include transmitting, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration. The operations of 1510 may be performed in accordance with examples as disclosed herein. In some examples, aspects of the operations of 1510 may be performed by a control message manager 1130 as described with reference to FIG. 11.

At 1515, the method may include transmitting a downlink control channel message based on the one or more control messages. The operations of 1515 may be performed in accordance with examples as disclosed herein. In some examples, aspects of the operations of 1515 may be performed by a downlink control channel message manager 1135 as described with reference to FIG. 11.

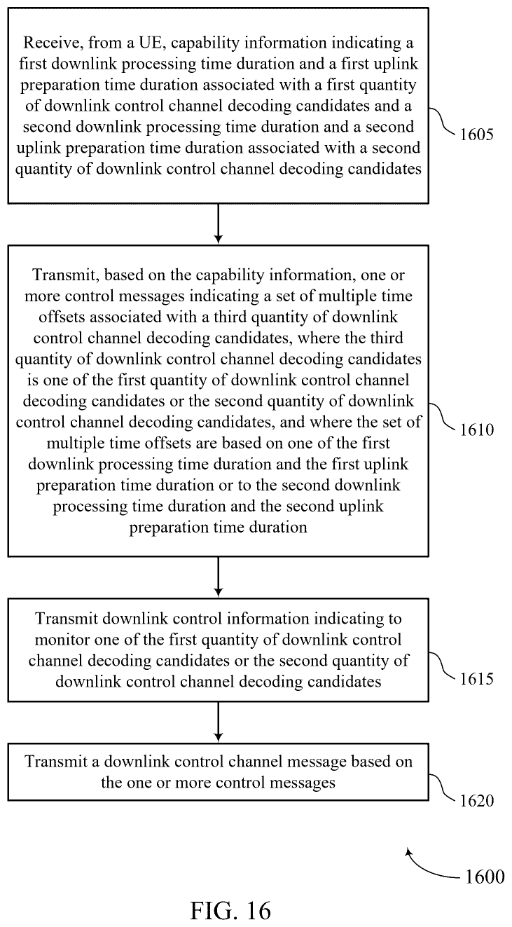

FIG. 16 shows a flowchart illustrating a method 1600 that supports techniques for configuring a timeline and quantity of downlink control channel decoding candidates in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates. The operations of 1605 may be performed in accordance with examples as disclosed herein. In some examples, aspects of the operations of 1605 may be performed by a capability information manager 1125 as described with reference to FIG. 11.

At 1610, the method may include transmitting, based on the capability information, one or more control messages indicating a set of multiple time offsets associated with a third quantity of downlink control channel decoding candidates, where the third quantity of downlink control channel decoding candidates is one of the first quantity of downlink control channel decoding candidates or the second quantity of downlink control channel decoding candidates, and where the set of multiple time offsets are based on one of the first downlink processing time duration and the first uplink preparation time duration or to the second downlink processing time duration and the second uplink preparation time duration. The operations of 1610 may be performed in accordance with examples as disclosed herein. In some examples, aspects of the operations of 1610 may be performed by a control message manager 1130 as described with reference to FIG. 11.

At 1615, the method may include transmitting downlink control information indicating to monitor one of the first quantity of downlink control channel decoding candidates or the second quantity of downlink control channel decoding candidates. The operations of 1615 may be performed in accordance with examples as disclosed herein. In some examples, aspects of the operations of 1615 may be performed by a control message manager 1130 as described with reference to FIG. 11.

At 1620, the method may include transmitting a downlink control channel message based on the one or more control messages. The operations of 1620 may be performed in accordance with examples as disclosed herein. In some examples, aspects of the operations of 1620 may be performed by a downlink control channel message manager 1135 as described with reference to FIG. 11.

The following provides an overview of aspects of the present disclosure:

Aspect 1: A method for wireless communications at a UE, comprising: transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates; receiving, based at least in part on the capability information, one or more control messages indicating a plurality of time offsets associated with a third quantity of downlink control channel decoding candidates, wherein the third quantity of downlink control channel decoding candidates is one of the first quantity of downlink control channel decoding candidates or the second quantity of downlink control channel decoding candidates, and wherein the plurality of time offsets are based at least in part on one of the first downlink processing time duration and the first uplink preparation time duration or the second downlink processing time duration and the second uplink preparation time duration; and monitoring one or more downlink control channel decoding candidates of the third quantity of downlink control channel decoding candidates based at least in part on the one or more control messages.

Aspect 2: The method of aspect 1, wherein a time offset of the plurality of time offsets comprise a first time duration between a downlink control channel and a downlink shared data channel corresponding to the downlink control channel; a second time duration between the downlink control channel and an uplink shared data channel; or a third time duration between the downlink shared data channel and a feedback channel.

Aspect 3: The method of any of aspects 1 through 2, wherein receiving the one or more control messages comprises: receiving the one or more control messages further indicating a second plurality of time offsets associated with a fourth quantity of downlink control channel decoding candidates, wherein: the third quantity of downlink control channel decoding candidates comprises the first quantity of downlink control channel decoding candidates; the fourth quantity of downlink control channel decoding candidates comprises the second quantity of downlink control channel decoding candidates; the plurality of time offsets are based at least in part on the first downlink processing time duration and the first uplink preparation time duration; the second plurality of time offsets are based at least in part on the second downlink processing time duration and the second uplink preparation time duration; and the one or more control messages comprise one or more RRC messages indicating to monitor one of the first quantity of downlink control channel decoding candidates or the second quantity of downlink control channel decoding candidates.

Aspect 4: The method of any of aspects 1 through 3, wherein receiving the one or more control messages comprises: receiving downlink control information indicating to monitor one of the first quantity of downlink control channel decoding candidates or the second quantity of downlink control channel decoding candidates.

Aspect 5: The method of any of aspects 1 through 4, wherein receiving control signaling deactivating downlink control channel skipping, wherein the third quantity of downlink control channel decoding candidates comprise at least one of: a quantity of the third quantity of downlink control channel decoding candidates; a difference between the third quantity of downlink control channel decoding candidates and a fourth quantity of downlink control channel decoding candidates when the downlink control channel skipping is deactivated; or a ratio of the third quantity of downlink control channel decoding candidates and the fourth quantity of downlink control channel decoding candidates.

Aspect 6: The method of any of aspects 1 through 5, wherein receiving the one or more control messages comprises: receiving the one or more control messages indicating the plurality of time offsets associated with the third quantity of downlink control channel decoding candidates and a second plurality of time offsets associated with a fourth quantity of downlink control channel decoding candidates, wherein the plurality of time offsets is associated with a first SSSG and the second plurality of time offsets is associated with a second SSSG.

Aspect 7: The method of aspect 6, further comprising: receiving, from the network entity, an indication of a first row of a TDRA table associated with the first SSSG and a second row of the TDRA table associated with the second SSSG; receiving a switch command indicating to switch from the first SSSG to the second SSSG; and monitoring one or more second downlink control channel decoding candidates of the fourth quantity of downlink control channel decoding candidates in accordance with the second row of the TDRA table based at least in part on the switch command.

Aspect 8: The method of any of aspects 6 through 7, further comprising: receiving, from the network entity, a switch command indicating to switch from the first SSSG to the second SSSG; and switching, based at least in part on the indication, from a first TDRA table associated with the first SSSG to a second TDRA associated with the second SSSG.

Aspect 9: The method of any of aspects 1 through 8, wherein the one or more control messages comprise one or more semi-persistent RRC messages.

Aspect 10: The method of any of aspects 1 through 9, further comprising: refraining from monitoring the one or more downlink control channel decoding candidates of the third quantity of downlink control channel decoding candidates based at least in part on one or more of a type of search space set being monitored by the UE, a DCI format of the one or more control messages indicating the third quantity of downlink control channel decoding candidates, a RNTI of the one or more control messages indicating the third quantity of downlink control channel decoding candidates, a reference signal type of one or more reference signals scheduled to be received by the UE via the one or more downlink control channel decoding candidates, or any combination thereof.

Aspect 11: The method of any of aspects 1 through 10, wherein the third quantity of downlink control channel decoding candidates associated with the plurality of time offsets are based at least in part on an amount of traffic of the UE satisfying a first threshold, an active number of UEs communicating with a cell serving the UE satisfying a second threshold, a delay sensitivity associated with providing service satisfying a third threshold, or a combination thereof.

Aspect 12: A method for wireless communications at a network entity, comprising: receiving, from a UE, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates; transmitting, based at least in part on the capability information, one or more control messages indicating a plurality of time offsets associated with a third quantity of downlink control channel decoding candidates, wherein the third quantity of downlink control channel decoding candidates is one of the first quantity of downlink control channel decoding candidates or the second quantity of downlink control channel decoding candidates, and wherein the plurality of time offsets are based at least in part on one of the first downlink processing time duration and the first uplink preparation time duration or to the second downlink processing time duration and the second uplink preparation time duration; and transmitting a downlink control channel message based at least in part on the one or more control messages.

Aspect 13: The method of aspect 12, wherein a time offset of the plurality of time offsets comprise a first time duration between a downlink control channel and a downlink shared data channel corresponding to the downlink control channel; a second time duration between the downlink control channel and an uplink shared data channel; or a third time duration between the downlink shared data channel and a feedback channel.

Aspect 14: The method of any of aspects 12 through 13, wherein transmitting the one or more control messages comprises: transmitting the one or more control messages further indicating a second plurality of time offsets associated with a fourth quantity of downlink control channel decoding candidates, wherein: the third quantity of downlink control channel decoding candidates comprises the first quantity of downlink control channel decoding candidates; the fourth quantity of downlink control channel decoding candidates comprises the second quantity of downlink control channel decoding candidates; the plurality of time offsets are based at least in part on the first downlink processing time duration and the first uplink preparation time duration; the second plurality of time offsets are based at least in part on the second downlink processing time duration and the second uplink preparation time duration; and the one or more control messages comprise one or more RRC messages indicating to monitor one of the first quantity of downlink control channel decoding candidates or the second quantity of downlink control channel decoding candidates.

Aspect 15: The method of any of aspects 12 through 14, wherein transmitting the one or more control messages comprises: transmitting downlink control information indicating to monitor one of the first quantity of downlink control channel decoding candidates or the second quantity of downlink control channel decoding candidates.

Aspect 16: The method of any of aspects 12 through 15, wherein transmitting control signaling deactivating downlink control channel skipping at the UE, wherein the third quantity of downlink control channel decoding candidates comprise at least one of: a quantity of the third quantity of downlink control channel decoding candidates; a difference between the third quantity of downlink control channel decoding candidates and a fourth quantity of downlink control channel decoding candidates when the downlink control channel skipping is deactivated; or a ratio of the third quantity of downlink control channel decoding candidates and the fourth quantity of downlink control channel decoding candidates.

Aspect 17: The method of any of aspects 12 through 16, wherein transmitting the one or more control messages comprises: transmitting the one or more control messages indicating the plurality of time offsets associated with the third quantity of downlink control channel decoding candidates and a second plurality of time offsets associated with a fourth quantity of downlink control channel decoding candidates, wherein the plurality of time offsets is associated with a first SSSG and the second plurality of time offsets is associated with a second SSSG.

Aspect 18: The method of aspect 17, further comprising: transmitting an indication of a first row of a TDRA table associated with the first SSSG and a second row of the TDRA table associated with the second SSSG; and transmitting a switch command indicating to switch from the first SSSG to the second SSSG, wherein the UE is to monitor one or more second downlink control channel decoding candidates of the fourth quantity of downlink control channel decoding candidates in accordance with the second row of the TDRA table based at least in part on the switch command.

Aspect 19: The method of any of aspects 17 through 18, further comprising: transmitting, to the UE, a switch command indicating to switch from the first SSSG to the second SSSG, wherein the UE is to switch from a first TDRA table associated with the first SSSG to a second TDRA associated with the second SSSG.

Aspect 20: The method of any of aspects 12 through 19, wherein the one or more control messages comprise one or more semi-persistent RRC messages.

Aspect 21: The method of any of aspects 12 through 20, wherein the third quantity of downlink control channel decoding candidates associated with the plurality of time offsets are based at least in part on an amount of traffic of the UE satisfying a first threshold, an active number of UEs communicating with a cell serving the UE satisfying a second threshold, a delay sensitivity associated with providing service satisfying a third threshold, or a combination thereof.

Aspect 22: A UE for wireless communications, comprising one or more memories storing processor-executable code, and one or more processors coupled with the one or more memories and individually or collectively operable to execute the code to cause the UE to perform a method of any of aspects 1 through 11.

Aspect 23: A UE for wireless communications, comprising at least one means for performing a method of any of aspects 1 through 11.

Aspect 24: A non-transitory computer-readable medium storing code for wireless communications, the code comprising instructions executable by one or more processors to perform a method of any of aspects 1 through 11.

Aspect 25: A network entity for wireless communications, comprising one or more memories storing processor-executable code, and one or more processors coupled with the one or more memories and individually or collectively operable to execute the code to cause the network entity to perform a method of any of aspects 12 through 21.

Aspect 26: A network entity for wireless communications, comprising at least one means for performing a method of any of aspects 12 through 21.

Aspect 27: A non-transitory computer-readable medium storing code for wireless communications, the code comprising instructions executable by one or more processors to perform a method of any of aspects 12 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates;
receive, based at least in part on the capability information, one or more control messages indicating a plurality of time offsets associated with a third quantity of downlink control channel decoding candidates, wherein the third quantity of downlink control channel decoding candidates is one of the first quantity of downlink control channel decoding candidates or the second quantity of downlink control channel decoding candidates, and wherein the plurality of time offsets are based at least in part on one of the first downlink processing time duration and the first uplink preparation time duration or the second downlink processing time duration and the second uplink preparation time duration; and
monitor one or more downlink control channel decoding candidates of the third quantity of downlink control channel decoding candidates based at least in part on the one or more control messages.

2. The UE of claim 1, wherein:
a first time duration between a downlink control channel and a downlink shared data channel corresponding to the downlink control channel;
a second time duration between the downlink control channel and an uplink shared data channel; or
a third time duration between the downlink shared data channel and a feedback channel.

3. The UE of claim 1, wherein, to receive the one or more control messages, the one or more processors are individually or collectively operable to execute the code to cause the UE to:
receive the one or more control messages further indicating a second plurality of time offsets associated with a fourth quantity of downlink control channel decoding candidates, wherein:
the third quantity of downlink control channel decode candidates comprises the first quantity of downlink control channel decoding candidates;
the fourth quantity of downlink control channel decode candidates comprises the second quantity of downlink control channel decoding candidates;
the plurality of time offsets be based at least in part on the first downlink processing time duration and the first uplink preparation time duration;
the second plurality of time offsets be based at least in part on the second downlink processing time duration and the second uplink preparation time duration; and
the one or more control messages comprise one or more radio resource control (RRC) messages indicating to monitor one of the first quantity of downlink control channel decoding candidates or the second quantity of downlink control channel decoding candidates.

4. The UE of claim 1, wherein, to receive the one or more control messages, the one or more processors are individually or collectively operable to execute the code to cause the UE to:
receive downlink control information indicating to monitor one of the first quantity of downlink control channel decoding candidates or the second quantity of downlink control channel decoding candidates.

5. The UE of claim 1, wherein:
receiving control signaling deactivating downlink control channel skipping, wherein the third quantity of downlink control channel decoding candidates comprise at least one of:
a quantity of the third quantity of downlink control channel decoding candidates;
a difference between the third quantity of downlink control channel decoding candidates and a fourth quantity of downlink control channel decoding candidates when the downlink control channel skipping is deactivated; or
a ratio of the third quantity of downlink control channel decoding candidates and the fourth quantity of downlink control channel decoding candidates.

6. The UE of claim 1, wherein, to receive the one or more control messages, the one or more processors are individually or collectively operable to execute the code to cause the UE to:
receive the one or more control messages indicating the plurality of time offsets associated with the third quantity of downlink control channel decoding candidates and a second plurality of time offsets associated with a fourth quantity of downlink control channel decoding candidates, wherein the plurality of time offsets is associated with a first search space set group (SSSG) and the second plurality of time offsets is associated with a second SSSG.

7. The UE of claim 6, wherein the one or more processors are individually or collectively further operable to execute the code to cause the UE to:
receive, from the network entity, an indication of a first row of a time domain resource allocation (TDRA) table associated with the first SSSG and a second row of the TDRA table associated with the second SSSG;
receive a switch command indicating to switch from the first SSSG to the second SSSG; and
monitor one or more second downlink control channel decoding candidates of the fourth quantity of downlink control channel decoding candidates in accordance with the second row of the TDRA table based at least in part on the switch command.

8. The UE of claim 6, wherein the one or more processors are individually or collectively further operable to execute the code to cause the UE to:
receive, from the network entity, a switch command indicating to switch from the first SSSG to the second SSSG; and
switching, based at least in part on the indication, from a first time domain resource allocation (TDRA) table associated with the first SSSG to a second TDRA associated with the second SSSG.

9. The UE of claim 1, wherein:
the one or more control messages comprise one or more semi-persistent radio resource control (RRC) messages.

10. The UE of claim 1, wherein the one or more processors are individually or collectively further operable to execute the code to cause the UE to:
refrain from monitoring the one or more downlink control channel decoding candidates of the third quantity of downlink control channel decoding candidates based at least in part on one or more of a type of search space set being monitored by the UE, a downlink control information (DCI) format of the one or more control messages indicating the third quantity of downlink control channel decoding candidates, a radio network temporary identifier (RNTI) of the one or more control messages indicating the third quantity of downlink control channel decoding candidates, a reference signal type of one or more reference signals scheduled to be received by the UE via the one or more downlink control channel decoding candidates, or any combination thereof.

11. The UE of claim 1, wherein the third quantity of downlink control channel decoding candidates associated with the plurality of time offsets are based at least in part on an amount of traffic of the UE satisfying a first threshold, an active quantity of UEs communicating with a cell serving the UE satisfying a second threshold, a delay sensitivity associated with providing service satisfying a third threshold, or a combination thereof.

12. A network entity, comprising:
one or more memories storing processor-executable code; and
one or more processors coupled with the one or more memories and individually or collectively operable to execute the code to cause the network entity to:
receive, from a user equipment (UE), capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates;
transmit, based at least in part on the capability information, one or more control messages indicating a plurality of time offsets associated with a third quantity of downlink control channel decoding candidates, wherein the third quantity of downlink control channel decoding candidates is one of the first quantity of downlink control channel decoding candidates or the second quantity of downlink control channel decoding candidates, and wherein the plurality of time offsets are based at least in part on one of the first downlink processing time duration and the first uplink preparation time duration or to the second downlink processing time duration and the second uplink preparation time duration; and
transmit a downlink control channel message based at least in part on the one or more control messages.

13. The network entity of claim 12, wherein:
a first time duration between a downlink control channel and a downlink shared data channel corresponding to the downlink control channel;
a second time duration between the downlink control channel and an uplink shared data channel; or
a third time duration between the downlink shared data channel and a feedback channel.

14. The network entity of claim 12, wherein, to transmit the one or more control messages, the one or more processors are individually or collectively operable to execute the code to cause the network entity to:
transmit the one or more control messages further indicating a second plurality of time offsets associated with a fourth quantity of downlink control channel decoding candidates, wherein:
the third quantity of downlink control channel decode candidates comprises the first quantity of downlink control channel decoding candidates;
the fourth quantity of downlink control channel decode candidates comprises the second quantity of downlink control channel decoding candidates;
the plurality of time offsets be based at least in part on the first downlink processing time duration and the first uplink preparation time duration;
the second plurality of time offsets be based at least in part on the second downlink processing time duration and the second uplink preparation time duration; and
the one or more control messages comprise one or more radio resource control (RRC) messages indicating to monitor one of the first quantity of downlink control channel decoding candidates or the second quantity of downlink control channel decoding candidates.

15. The network entity of claim 12, wherein, to transmit the one or more control messages, the one or more processors are individually or collectively operable to execute the code to cause the network entity to:
transmit downlink control information indicating to monitor one of the first quantity of downlink control channel decoding candidates or the second quantity of downlink control channel decoding candidates.

16. A method for wireless communications at a user equipment (UE), comprising:
transmitting, to a network entity, capability information indicating a first downlink processing time duration and a first uplink preparation time duration associated with a first quantity of downlink control channel decoding candidates and a second downlink processing time duration and a second uplink preparation time duration associated with a second quantity of downlink control channel decoding candidates;
receiving, based at least in part on the capability information, one or more control messages indicating a plurality of time offsets associated with a third quantity of downlink control channel decoding candidates, wherein the third quantity of downlink control channel decoding candidates is one of the first quantity of downlink control channel decoding candidates or the second quantity of downlink control channel decoding candidates, and wherein the plurality of time offsets are based at least in part on one of the first downlink processing time duration and the first uplink preparation time duration or the second downlink processing time duration and the second uplink preparation time duration; and
monitoring one or more downlink control channel decoding candidates of the third quantity of downlink control channel decoding candidates based at least in part on the one or more control messages.

17. The method of claim 16, wherein a time offset of the plurality of time offsets comprise:
a first time duration between a downlink control channel and a downlink shared data channel corresponding to the downlink control channel;
a second time duration between the downlink control channel and an uplink shared data channel; or
a third time duration between the downlink shared data channel and a feedback channel.

18. The method of claim 16, wherein receiving the one or more control messages comprises:
receiving the one or more control messages further indicating a second plurality of time offsets associated with a fourth quantity of downlink control channel decoding candidates, wherein:
the third quantity of downlink control channel decoding candidates comprises the first quantity of downlink control channel decoding candidates;
the fourth quantity of downlink control channel decoding candidates comprises the second quantity of downlink control channel decoding candidates;
the plurality of time offsets are based at least in part on the first downlink processing time duration and the first uplink preparation time duration;
the second plurality of time offsets are based at least in part on the second downlink processing time duration and the second uplink preparation time duration; and
the one or more control messages comprise one or more radio resource control (RRC) messages indicating to monitor one of the first quantity of downlink control channel decoding candidates or the second quantity of downlink control channel decoding candidates.

19. The method of claim 16, wherein receiving the one or more control messages comprises:
receiving downlink control information indicating to monitor one of the first quantity of downlink control channel decoding candidates or the second quantity of downlink control channel decoding candidates.

20. The method of claim 16, wherein:
receiving control signaling deactivating downlink control channel skipping, wherein the third quantity of downlink control channel decoding candidates comprise at least one of:
a quantity of the third quantity of downlink control channel decoding candidates;
a difference between the third quantity of downlink control channel decoding candidates and a fourth quantity of downlink control channel decoding candidates when the downlink control channel skipping is deactivated; or
a ratio of the third quantity of downlink control channel decoding candidates and the fourth quantity of downlink control channel decoding candidates.
